(19) United States
(12) Patent Application Publication
(10) Pub. No.: US 2017/0310581 A1
(43) Pub. Date: Oct. 26, 2017

(54) Communication Network, Communication Network Management Method, and Management System

(71) Applicant: Hitachi, Ltd., Chiyoda-ku, Tokyo (JP)

(72) Inventors: Hideki ENDO, Tokyo (JP); Takumi OISHI, Tokyo (JP)

(21) Appl. No.: 15/507,954

(22) PCT Filed: May 29, 2015
(86) PCT No.: PCT/JP2015/065681

§ 371 Date: Mar. 1, 2017

(51) Int. Cl. H04L 12/725; H04L 12/24; H04L 12/26

(52) U.S. Cl. CPC H04L 45/302; H04L 43/0882; H04L 41/0677; H04L 41/5019

(57) ABSTRACT

Disclosed is a communication network management method provided with a plurality of communication devices and a management system to transmit packets between a plurality of communication devices through a communication path established by the management system. The management system establishes a communication path for a first service necessitating a guarantee of an availability factor on the basis of a first establishment policy in which communication paths that share the same route even in a part of the communication network are consolidated. The management system establishes a communication path for a second service that does not necessitate a guarantee of an availability factor on the basis of a second establishment policy in which the routes to be used are distributed over the entire communication network. The establishment policy is changed depending on a service type.

### TECHNICAL FIELD

The present invention relates to a packet communication system, particularly to communication system for accommodating a plurality of different services, and more particularly to a packet communication system and a communication device capable of a service level agreement (SEA) guarantee.

### BACKGROUND ART

In a conventional communication network, systems established independently for each communication service to be provided. This is because qualities required for each service are different, and network establishment and maintenance methods are significantly different service by service. For example, in an business user communication service as a representative dedicated line used is mission-critical works such as national defense finance, a 100% communication bandwidth guarantee or a one-year availability factor of, for example, 99.99% is desired.

Meanwhile, in a public consumer communication service such as the Internet access in wired or wireless telephony, a service outage for several hours for a maintenance purpose is allowable. However, surging traffics are to be effectively and fairly allocated to users.

A communication service provider provides a communication service within the terms of contracts with users by defining a communication quality (such as a bandwidth or delay) guarantee, an availability factor guarantee, and the like. If the SLA is not satisfied, the communication service provider is required to reduce a service fee or pay compensation. Therefore, the SLA guarantee is very important.

The most important thing in the SLA guarantee is a communication quality such as bandwidth or delay. In order to guarantee a communication bandwidth or delay, it is necessary to search a route capable of satisfying a requested level in the network and allocate the route to each user or service. In a communication system of the prior art, a route tracing method such as the Dijkstra's algorithm is employed, in which costs of links on the route are summed, and a route having the minimum sum or a route having the maximum sum is selected. Here, computation is performed by converting the communication bandwidth or delay into costs of each link on the route.

In this route tracing method, a route capable of accommodating more packet communication traffics is selected, for example, by expressing a physical bandwidth of the link as a cost of the link and computing a route having the maximum sum of the cost or a route having the minimum sum of the cost for the links on the route. However, in this route tracking method, only the sum of the cost for the links on the route is considered. Therefore, if a cost of a single link is extremely high or low, this link becomes a bottle neck and generates a problem such as a traffic jam. In this regard, in order to address such a problem, there is known an advanced Dijkstra method in which a difference of the cost of each link on the route is also considered in addition to the sum of the cost for the link on the route (see Patent Document 1). Using this method, the bottle neck problem can be avoided, and a path capable of the SLA guarantee can be searched.

An availability factor of the SLA fully depends on maintainability. In a dedicated line service having the SLA containing the availability factor, overall communication devices have an operations, administration, and maintenance (CAM) tool for detecting a failure on the communication route in order to detect a failure within a short time and automatically switch to an alternative route prepared in advance. In case of multiple failures generated when this alternative route is also failed, a physical failure position is specified by applying a connectivity verification CAM tool such as a loopback test to the failed route, and a maintenance work such as part replacement is performed, so that the availability factor can be guaranteed in any case.

However, in recent years, the communication networks are widely employed, and a profit source is changed to services or application service providers. Therefore, profitability of communication service providers that provide communication services reaches its critical point. For this reason, communication carriers try to improve profitability by reducing the cost of the current communication service and adding a new value to the communication service. In this regard, communication service providers that provide various communication services try to reduce the service cost by sharing devices and using a consolidated network capable of accommodating various services instead of a network established independently for each service as in the prior art. In addition, although a service opening work or a network change work caused by a change of the SLA took several hours or several months in the past, the time necessary for such a work has been reduced to several seconds or several minutes recently. As a result, the communication service providers to increase their incomes by providing an optimum network in a timely manner in response to a request from a user or an application service provider.

In order to establish such a network by consolidating services, it is indispensable to logically virtualize the network and multiplex the network into physical channels or communication devices. For this purpose, there is known a virtual private network (VPN) technology such as a multi-protocol label switching (MPLS).

In order to accommodate a plurality of services in a single network using the VPN technology, each service and users thereof are accommodated in the network using logical paths. For example, if the Ethernet (registered trademark) is accommodated in the MPLS, each user or service of the Ethernet is mapped to psudo wire (PW), and the mapping result is further mapped to the MPLS network path (MPLS path).

The multi-protocol label switching (MPLS) path is a route included in the MPLS network and designated by a path ID. A packet arriving at the MPLS device from the Ethernet encapsulated with the MPLS label including this path ID and is transmitted along the route of the MPLS network. For this reason, a plurality of services can be multiplexed by uniquely determining a route of the MPLS network depending on which path ID is allocated to each user or service and accommodating a plurality of logical paths in the physical channel. This virtual network for each service is called a “virtual network.”

In the MPLS, an operations, administration, and management (OAM) tool for improving maintainability is defined. A failed route can rapidly switch to an alternative route by rapidly detecting a failure in each logical path using an OAM tool that periodically transmits and receives an OAM packet to and from the start and end points of the logical path (see Non-patent Document 1).

In addition, the failure detected from the start or end point of the logical path is notified from the communication device to an operator through a network management system. As a result, the operator executes a loopback test OAM tool that transmits a loopback OAM packet to a relay point on the logical path in order to specify a failure position on the failed logical path (see Non-patent Document 2). As a result, a physical failure portion is specified on the basis of the failure portion on the logical path. Therefore, it is possible to perform a maintenance work such as part effect.

Under an environment in which the virtual network for consolidating a plurality of services as described above dynamically changed, it is difficult to appropriately respond to demands for the SLA guarantee of each service through setting or management made by an operator (human being) as in the prior art. In this regard, it is conceived that a policy regarding a communication quality such as bandwidth or delay is defined for each service, and a network management server (network management system) computes the corresponding route and automatically establishes the logical path (see Patent Document 2). As a result, it is possible to establish or change a network capable of guaranteeing the communication quality of each service without an operator.

As described above, in the communication system of the prior art, the availability factor can be guaranteed using the OAM tool. Therefore, only the communication such as bandwidth or delay was considered in the route tracing.

### CITATION LIST

### Patent Document

Patent Document 1: JP 2001-244974 A

Patent Document 2: JP 2004-236030 A

### Non-Patent Document

Non-Patent Document 1: IETF RFC6426 (Proactive Connectivity Verification, Continuity Check, and Remote Defect Indication for the MPLS Transport Profile)

Non-Patent Document 2: IETF RFC6426 (MPLS On-Demand Connectivity Verification and Route Tracing)

### SUMMARY OF THE INVENTION

### Problems to be Solved by the Invention

However, if the route of the logical path is computed by considering only the communication quality in the virtual network in which a plurality of services are consolidated, accommodation of traffics without wasting resources in the entire network is most important. Therefore, the logical path is established distributedly over the entire virtual network.

The number of public consumers that use the network such as the Internet is larger by two or more digits than the number of business users that require a guarantee of the availability factor in addition to the communication quality. Therefore, the number of users affected by failure occurrence becomes huge. For this reason, it Was difficult to rapidly find a failure detected on the logical path dedicated to the business user necessitating the availability factor guarantee and immediately make troubleshooting. As a result, the time taken for specifying a failure portion and performing a subsequent maintenance work such as part replacement increases, so that it is difficult to guarantee the availability factor disadvantageously.

### Solutions to Problems

In view of the aforementioned problem, according to an aspect of the present invention, there is provided a packet communication system including a plurality of communication devices and a management system for managing the communication devices to transmit packets between a plurality of communication devices through a communication path established by the management system. In this packet communication system, the management system establishes the communication path by changing a path establishment policy depending on a service type. For example, in a first path establishment policy, paths that share the same route even in a part of the network are consolidated in order to maintainability. In a second path establishment policy, the are distributed over entire network in order to effectively accommodate traffics.

Specifically, out of the services accommodated in the packet communication system according to the present invention, the service in which the paths are consolidated is a service for guaranteeing a certain bandwidth for each user or service. In this service, if a total sum of service bandwidths consolidated in the same route exceeds any channel bandwidth on the path, another route is searched and established such that a total sum of service bandwidths consolidated in the same route does not exceed any channel bandwidth on the route. In addition, in the service in which the routes are distributed, the paths are distributed depending on the remaining bandwidth obtained by subtracting the bandwidth dedicated to the path consolidating service from each channel bandwidth of the route.

Specifically, the packet communication system according to the present invention changes the path in response to a request from an external connected system such as a user on the Internet or a data center by automatically applying the path establishment policy.

Specifically, when failures are detected from a plurality of paths, the communication device of the packet communication system according to the present invention preferentially notifies the management system of a failure of the path relating to the service necessitating an availability factor guarantee. In addition, the management system preferentially processes a failure notification relating to the service necessitating an availability factor guarantee and automatically executes a loopback test or urges an operator to execute the loopback test.

According to another aspect of the present invention, there is provided a communication network management method having a plurality of communication devices and a management system, in which a packet is transmitted between the plurality of communication devices through a communication path established by the management system. The method includes: establishing the communication path by the management system on the basis of a first establishment policy in which communication paths that share the same route even in a part of the communication network are consolidated for a first service necessitating an availability factor guarantee; establishing the communication path by the management system on the basis of a second establishment policy in which a route to be used distributed over the entire communication network for a second service that does not necessitate the availability factor guarantee; and changing the establishment policy depending on a service type.

According to another aspect of the present invention, there is provided a communication network management system for managing a plurality of communication devices in a communication network in which a communication path for a first service that guarantees a bandwidth for a user and a communication path for a second service that does not guarantee a bandwidth for a user are established, and the communication paths for the first and second services coexist in the communication network. This communication network management system applies a first establishment policy in which a new communication path is established in a route selected from routes having unoccupied bandwidths corresponding to the guarantee bandwidth in response to a new communication path establishment request for the first service. The communication network management system applies a second establishment policy applies a second establishment policy in which the new communication path is established in a route selected from unoccupied bandwidths allocated to the second service user in response to a new communication path establishment request for the second service.

Specifically, on the basis of the first establishment policy, the new communication path is established by selecting a route having a minimum unoccupied bandwidth from routes having the unoccupied bandwidth corresponding to the guarantee bandwidth. In addition, on the basis of the second establishment policy, the new communication path is established by selecting a route having a maximum unoccupied bandwidth allocated to each second service user or a bandwidth equal to or higher than a predetermined threshold. According to this establishment policy, the first service communication path is established such that the route is shared as much as possible. In addition, the second service communication path is established such that the bandwidths available for users are distributed as evenly as possible.

According to still another aspect of the present invention, there is provided a communication network including: a plurality of communication devices that constitute a route; and a management system that establishes a communication path occupied by a user across the plurality of communication devices. In this communication network, the management system establishes a first service communication path and a second service communication path having different SLAs for the user's occupation. In addition, the first service communication path is established such that the first service communication paths are consolidated into a particular route in the network, and the second service communication path is established such that the second service communication paths are distributed to routes over the network.

Specifically, the first service is a service in which an availability factor and a bandwidth are guaranteed. If a plurality of communication paths used for a plurality of users provided with the first service have the same source port and the same destination port over the network, the plurality of communication paths are established in the same route. In addition, the second service is a best-effort service. The second service communication path is established such that the unoccupied bandwidths except for the communication bandwidth used by the first service communication path are evenly allocated to the second service users.

### Effects of the Invention

It is possible to configure a communication network capable of accommodating a plurality of services having different SLAs. In addition, it is possible to reduce cost by consolidating services of the communication service providers and improve convenience by providing an optimum network in a timely manner.

### BRIEF DESCRIPTION OF THE DRAWINGS

FIG. 1 is a block diagram illustrating a configuration of a communication system according to an embodiment of the present invention.

FIG. 2 is a block diagram illustrating a network management system according to an embodiment of the present invention.

FIG. 3 is a table diagram illustrating an exemplary path establishment policy table provided in the network management system of FIG. 2.

FIG. 4 is a table diagram illustrating an exemplary user management table provided is the network management system of FIG. 2.

FIG. 5 is a table diagram illustrating an exemplary access point management table provided in the network management system of FIG. 2.

FIG. 6 is a table diagram illustrating an exemplary path configuration table provided in the network management system of FIG. 2.

FIG. 7 is a table diagram illustrating an exemplary link management table provided in the network management system of FIG. 2.

FIG. 8 is a table diagram illustrating an exemplary format of an Ethernet communication packet used in the communication system according to an embodiment of the invention.

FIG. 9 is a table diagram illustrating a format of an MPLS communication packet used in the communication system according to an embodiment of the invention.

FIG. 10 is a table diagram illustrating an exemplary format of an MPLS communication OAM packet used in the communication system according to an embodiment of the invention.

FIG. 11 is a block diagram illustrating an exemplary configuration of a communication device ND#n according to an embodiment of the invention.

FIG. 12 is a table diagram illustrating an exemplary format of an intra-packet header added to an input packet of the communication device ND#n.

FIG. 13 is a table diagram illustrating an exemplary connection ID decision table provided in a network interface board 10-n of FIG. 11.

FIG. 14 is a table diagram illustrating an exemplary input header processing table provided in the network interface board 10-n of FIG. 11.

FIG. 15 is a table diagram illustrating an exemplary label setup table provided in the network interface board 10-n of FIG. 11.

FIG. 16 is a table diagram illustrating an exemplary bandwidth monitoring table provided in the network interface board 10-n of FIG. 11.

FIG. 17 is a table diagram illustrating an exemplary packet transmission table provided in a switch unit 11 of FIG. 11.

FIG. 18 is a flowchart illustrating an exemplary input packet process S100 executed by the input packet processing unit 103 of FIG. 11.

FIG. 19 is a table diagram illustrating an exemplary failure management table provided in the network interface board 10-n of FIG. 11.

FIG. 20 is a sequence diagram illustrating an exemplary network establishment sequence SQ100 from an operator executed by the communication system according to an embodiment of the invention.

FIG. 21 is a sequence diagram illustrating an exemplary network establishment sequence SQ200 from a user terminal executed by the communication system according to an embodiment of the invention.

FIG. 22 is a sequence diagram illustrating an exemplary network establishment sequence SQ300 from a data center executed by the communication system according to an embodiment of the invention.

FIG. 23 is a sequence diagram illustrating an exemplary failure portion specifying sequence SQ400 executed by the communication system according to an embodiment of the invention.

FIG. 24 is a flowchart illustrating an exemplary service-based path search process S200 executed by the network management system of FIG. 2.

FIG. 25 a part of the flowchart illustrating an exemplary service-based path search process S200 executed by the network management system of FIG. 2.

FIG. 26 is a flowchart illustrating an exemplary failure management polling process executed by the network interface board 10-n of FIG. 11.

FIG. 27 is a flowchart illustrating a failure notification cue reading process S400 executed by the device management unit 12 of FIG. 12

FIG. 28 is a flowchart illustrating an exemplary service-based path search process S2800 executed by a network management system in a communication system according to another embodiment of the invention.

FIG. 29 is a part of the flowchart illustrating an exemplary service-based path search process S2800 executed by a network management system in a communication system according to another embodiment of the invention.

FIG. 30 is a sequence diagram illustrating a network presetting sequence SQ1000 from an operator executed by a communication system according to another embodiment of the invention.

FIG. 31 is a flowchart illustrating an exemplary preliminary path search process S500 executed by the network management system according to an embodiment of the invention.

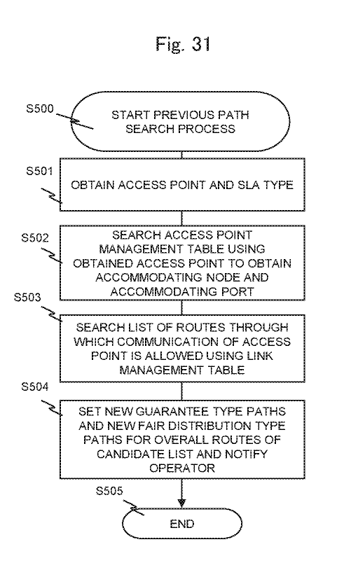

FIG. 32 is a table diagram illustrating another exemplary path configuration table provided in the network management system according to an embodiment of the invention.

### MODE FOR CARRYING OUT THE INVENTION

Embodiments of the present invention will now be described with reference to the accompanying drawings. It would be appreciated that the scope of the invention is not limited to those described in the embodiments below. A person skilled in the art would easily anticipate that any of the specific configurations may be changed without departing from the scope and spirit of the invention.

In the following description, like reference numerals denote like elements throughout several drawings, and they will not be described repeatedly.

Herein, ordinal expressions such as “first,” “second,” and “third” are to identify elements and are not intended to necessarily limit their numbers or orders. The reference numerals for identifying elements are inserted for each context, and thus, a reference numeral inserted in a single context does not necessarily denote the same element in other contexts. Furthermore, an element identified by a certain reference numeral may also have a functionality of another element identified by another reference numeral.

Throughout the drawings, a form factor such as the position, size, shape, and range of an element may not match its actual value in some cases for convenience purposes. For this reason, the position, size, shape, and range of an element are not necessarily limited to those disclosed in drawings.

### Embodiment 1

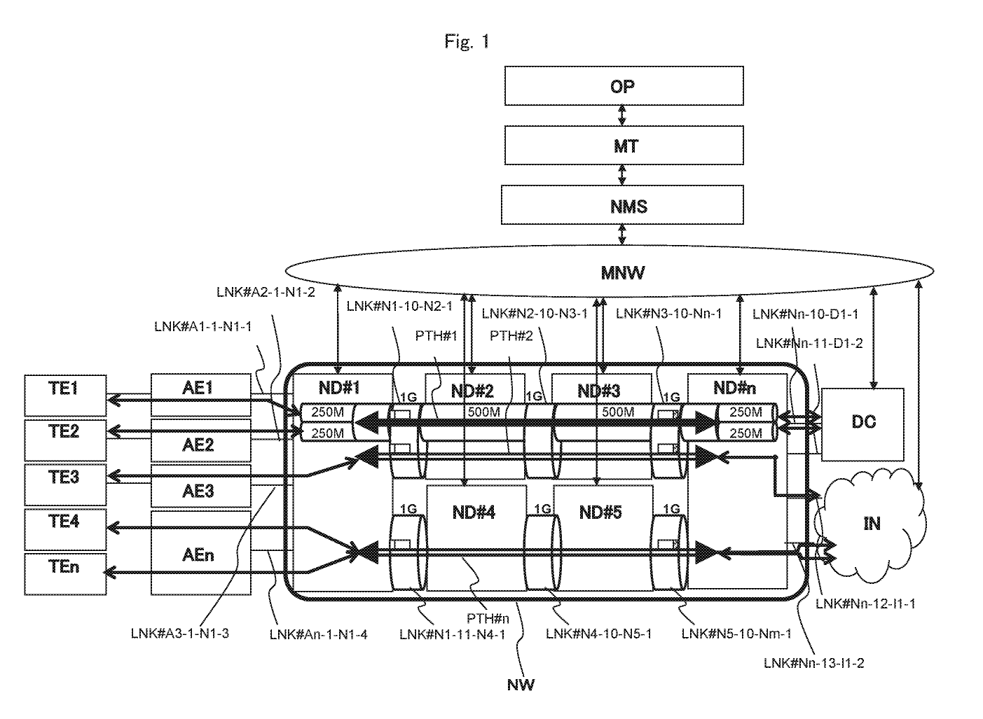

FIG. 1 illustrates an exemplary communication system according to the present invention. This system is a communication system having a plurality of communication devices and a management system thereof to transmit a packet between a plurality of communication devices through a communication path established by the management system. Here, when the management system establishes the communication path, for a service necessitating an availability factor guarantee, a plurality of path establishment policies can be changed on a service-by-service basis. For example, paths that share the same route even in a part of the network may be consolidated to rapidly specify a failure portion, or a route may be distributed over the entire network in order to accommodate traffics fairly between a plurality of users for a service capable of accommodating abundant traffics from a plurality of users without necessity of the availability factor guarantee.

The communication devices ND#1 to ND#n according to this embodiment constitute a communication service provider network NW used to connect access units AE1 to AEn for accommodating user terminals TE1 to TEn and a data center DC or the Internet IN to each other. The communication devices ND#1 to ND#n included in this network NW may be edge devices and repeaters having the same device configuration, or they may be operated as an edge device or a repeater depending on presetting or an input packet. In FIG. 1, for convenience purposes, it is assumed that the communication devices ND#1 and ND#n serve as edge devices, and the communication devices ND#2, ND#3, ND#4, and ND#5 serve as repeaters considering a position in the network NW.

Each communication device ND#1 to ND#n is connected to the network management system NMS through the management network MNW. The Internet IN including a server for processing a user's request or a data center DC prodded in application service provider for cooperation between the communication system of this communication service provider and management of users or application service providers is also connected to the management network MNW.

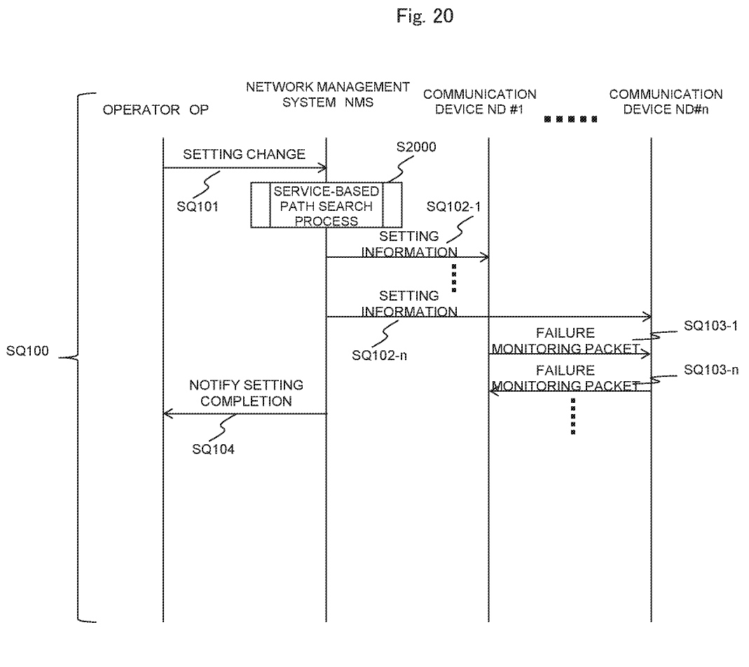

Each logical path is established by the network management system (as described below in conjunction with sequence SQ100 of FIG. 20). Here, the paths PTH#1 and PTH#2 pass through the repeaters ND#2 and ND#3, and the path PTH#n passes through the repeaters ND#4 and ND#5. All of them are distributed between the edge device ND#1 and the edge device ND#n. In this example of FIG. 1, the network management system NMS allocates a bandwidth of 500 Mbps to the path PTH#1 in order to allow the path PTH#1 to serve as a path for guaranteeing an business user communication service. This is because the business user that uses the user terminals TE1 and TE2 signed a communication service contract for allocating a bandwidth of 250 Mbps to each user terminal TE1 and TE2, and the path PTH#1 of the corresponding user is guaranteed with a sum of bandwidths of 500 Mbps. Meanwhile, the paths PTH#2 and PTH#n occupied by the user terminals TE3, TE4, and TEn for public users are dedicated to a public consumer communication service and are operated in a best-effort manner. Therefore, the bandwidth is not secured, and only connectivity between the edge devices ND#1 and ND#n is secured.

As described above, in the communication system of FIG. 1, the business user communication path and the public user communication path having different SLA guarantee levels are allowed to pass through the same communication device.

Such a path establishment or change is executed when an operator OP as a typical network administrator instructs the network management system NMS using a monitoring terminal MT. However, since the current communication service providers try to obtain new incomes by providing an optimum network in response to a request from a user or an application service provider, the instruction for establishing or changing the path is also issued from the Internet IN or the data center DC as well as the operator.

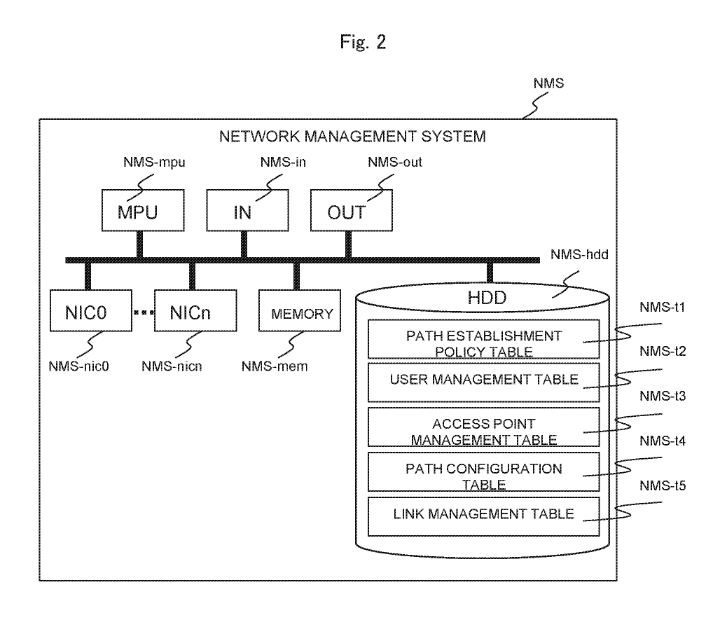

FIG. 2 illustrates an exemplary configuration of the network management system NMS.

Since the network management system NMS is implemented as a general purpose server, is configuration includes a microprocessing unit (MPU) NMS-mpu for executing a program, a hard disk drive (HDD) NMS-hdd for storing information necessary to install or process the program, a memory NMS-mem for temporarily holding such information for the processing of the MPU NMS-mpu, an input unit NMS-in and an output unit NMS-out used to exchange a signal of the monitoring terminal MT manipulated by an operator OP, and a network interface card (NIC) NMS-nic used for connection with the management network MNW.

Information necessary to manage the network NW according to this embodiment, such as a path establishment table NMS-t1, a user management table NMS-t2, an access point management table NMS-t3, a path configuration table NMS-t4, and a link management table NMS-t5 is stored in the HDD NMS-hdd. Such information is input from and changed by an operator OP depending on a change of the network NW condition in response to a request from a user or an application service provider.

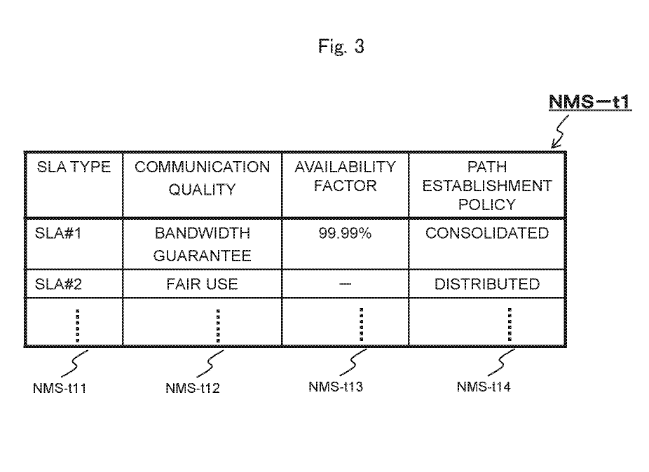

FIG. 3 illustrates an exemplary path establishment policy table NMS-t1. The path establishment policy table NMS-t1 is to search table entries indicating a communication policy table NMS-t12, an availability factor guarantee NMS-t13, and a path establishment policy NMS-t14 by using the SLA type NMS-t11 as a search key.

Here, the SLA type NMS-t11 identifies a business user communication service or a public consumer communication service. Depending on the SLA type NMS-t11, a method of guaranteeing the communication quality NMS-t12 (bandwidth guarantee or fair distribution), whether or not the availability factor guarantee NMS-t13 is allowed (if allowed, its reference value), or the path establishment policy NMS-t14 such as “CONSOLIDATED” or “DISTRIBUTED” can be searched. Hereinafter, the business user communication service will be referred to as a “guarantee type service,” and the public consumer communication service will be referred to as a “fair distribution type service.” How to use this table will be described below in more details.

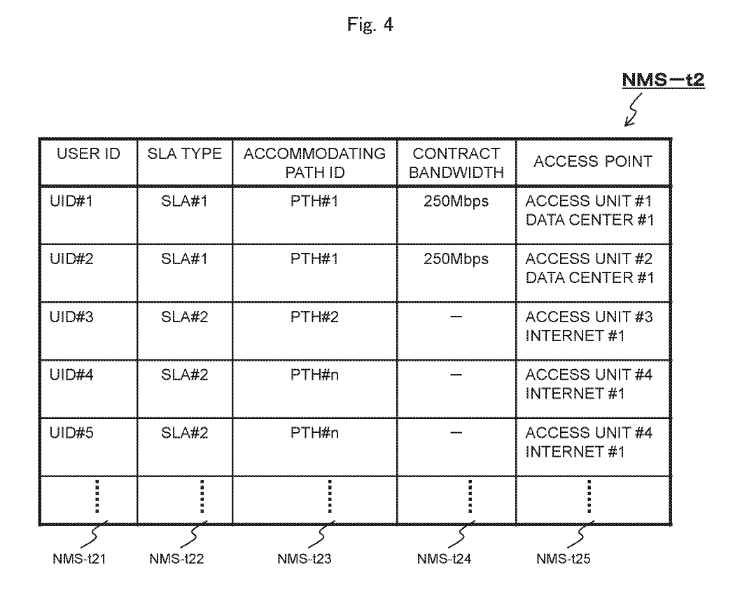

FIG. 4 illustrates an exemplary user management table NMS-t2. The user management table NMS-t2 is to search table entries indicating a SLA type NMS-t22, an accommodating path ID NMS-t23, a contract bandwidth NMS-t24, and an access point NMS-t25 by using the user ID NMS-t21 as a search key.

Here, the user ID NMS-t21 identifies each service terminal TEn connected through the user access unit AEn. For each user ID NMS-t21, the SLA type NMS-t22, the accommodating path ID NMS-t23 for this user terminal TEn, the contract bandwidth NMS-t24 allocated to each user terminal TEn, and the access point NMS-t25 of this user terminal TEn can be searched. Here, any one of the path IDs NMS-t41 as a search key of the path configuration table NMS-t4 described below is established in the accommodating path ID NMS-t23 as a path for accommodating the corresponding user. How to use this table will be described below in more details.

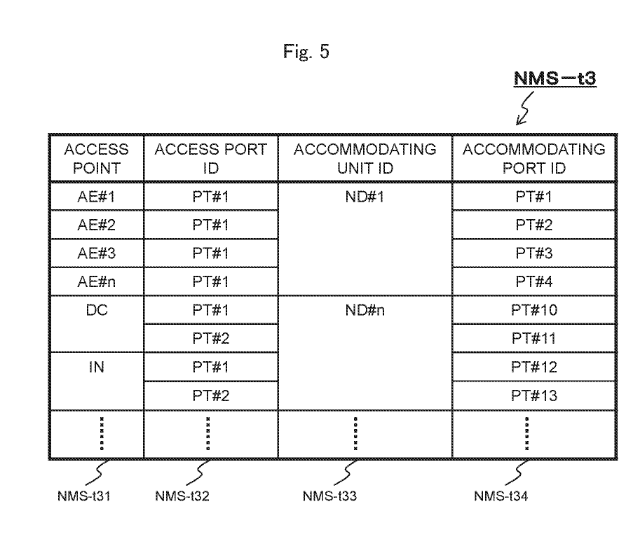

FIG. 5 illustrates an exemplary access point management table NMS-t3. The access point management table NMS-t3 is to search table entries indicating an accommodating unit ID NMS-t33 and an accommodating port ID NMS-t34 by using a combination the access point NMS-t31 and an access port ID NMS-t32 as a search key.

Here, the access point NMS-t31 and the access port ID NMS-t32 represent a point serving as a transmit/receive source of traffics in the network NW. The accommodating unit ID NMS-t33 and the accommodating port ID NMS-t34 representing a point of the network NW used to accommodate them can be searched. How to use this table will be described below in more details.

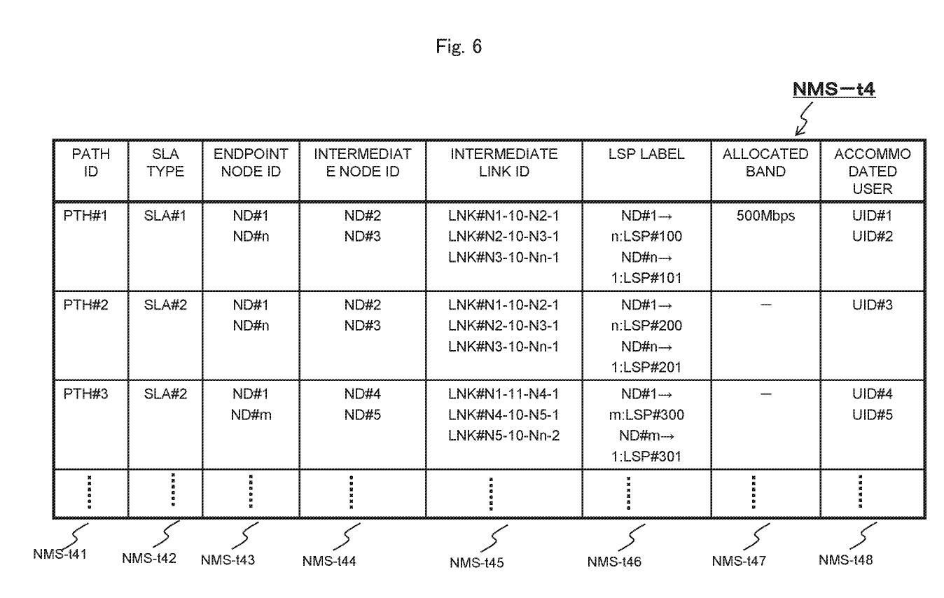

FIG. 6 illustrates a path configuration table NMS-t4. The path configuration table NMS-t4 is to search table entries indicating a SLA type NMS-t42, an endpoint node ID NMS-t43, an intermediate node ID NMS-t44, an intermediate link ID NMS-t45, a LSP label NMS-t46, an allocated bandwidth NMS-t47, and an accommodated user NMS-t48 by using a path ID NMS-t41 as a search key.

Here, the path ID NMS-t41 is a value for management for uniformly identifying a path in the network NW and is designated to be the same in both sides of the communication unlike an LSP label actually given to a packet. The SLA type NMS-t42, the endpoint node ID NMS-t43 of the corresponding path, the intermediate node ID NMS-t44, the intermediate link ID NMS-t45, and the LSP label NMS-t46 are set for each path ID NMS-t41.

If the SLA type NMS-t42 of the corresponding path indicates a guarantee type service (SLA#1 in the example of FIG. 6), a sum of the contract bandwidths for all users described in the ACCOMMODATED USER NMS-t48 is set in the ALLOCATED BANDWIDTH NMS-t47.

Meanwhile, if the corresponding path is a fair distribution type service path (SLA#2 in the example of FIG. 6), all of the users accommodated in the corresponding path are similarly set as the ACCOMMODATED USER NMS-t48, and an invalid value is set in the ALLOCATED BANDWIDTH NMS-t47.

The LSP label NMS-t46 is an LSP label actually given to a packet and is set to a different value depending on a communication direction. In general, a different LSP label may be set whenever the communication device ND#n is relayed. However, according to this embodiment, for simplicity purposes, it is assumed that the LSP label is not changed whenever the communication device ND#n is relayed, and the same LSP label is used between edge devices in the network. How to use this table will be described below in more details.

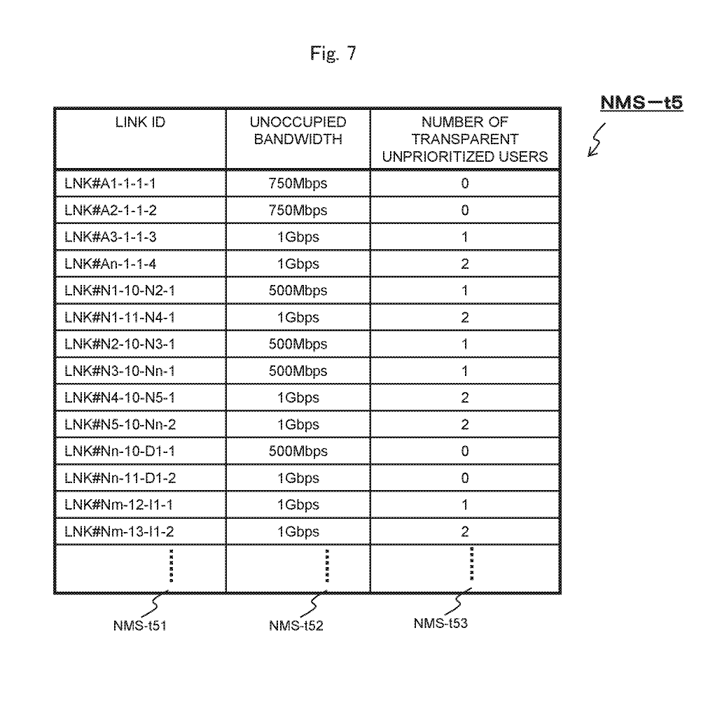

FIG. 7 illustrates a link management table NMS-t5. The link management table NMS-t5 is to search table entries indicating an unoccupied bandwidth NMS-t52 and the number or transparent unprioritized users NMS-t53 by using a link ID NMS-t51 as a search key.

Here, the link ID NMS-t51 represents a port connection relationship between each communication devices and is set as a combination of the communication device ND#n in both ends of each link and its port ID. For example, if the port PT#2 of the communication device ND#1 and the port PT#4 of the communication device ND#3 are connected to form a single link, the link ID NMS-t51 becomes “LNK#N1-2-N3-4.” the path having the same link ID, that is, a path having the same combination of the source and destination ports is a path on the same route.

For each of the link ID NMS-t51, a value obtained by subtracting a sum of the contract bandwidths of the path passing through the corresponding link from a physical bandwidth of the corresponding link is stored as the unoccupied bandwidth NMS-t52, and the number of the fair distribution type service users on the path passing through the corresponding link is stored as the number of transparent unprioritized users NMS-t53, so that the search possible. How to use this table will be described below in more details.

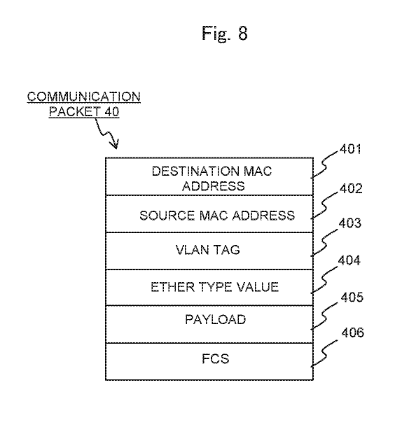

A format of the packet employed in this embodiment will be described with reference to FIGS. 8 to 10.

FIG. 8 illustrates a format of the communication packet 40 received by the edge devices ND#1 and ND#n from the access units AE#1 to AE#n, the data center DC, and the Internet IN.

The communication packet 40 includes a destination MAC address 401, a source MAC address 402, a VLAN tag 403, a MAC header containing a type value 404 representing a type of the subsequent header, a payload section 405, and a packet check sequence (FCS) 406.

The destination MAC address 401 and the source MAC address 402 contain a MAC address allocated to any one of the user terminals TE1 to TEn, the data center DC, the Internet IN. The VLAN tag 403 contains a VLAN ID value (VID#) serving as flow identifier and a CoS value representing a priority.

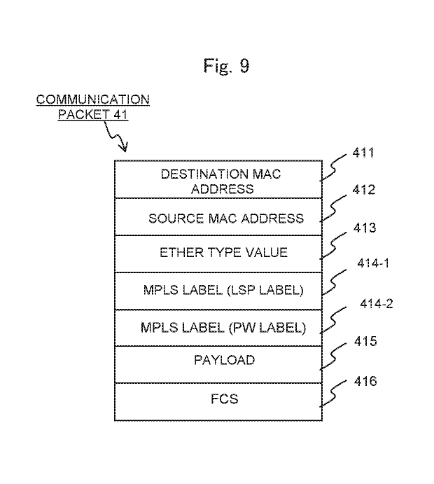

FIG. 9 illustrates a format of the communication packet 41 transmitted or received by each communication device ND#n in the network NW. In this embodiment, it is assumed that a psudo wire PW format used to accommodate the Ethernet using the MPLS is employed.

The communication packet 41 includes a destination MAC address 411, a source MAC address 412, a MAC header containing a type value 413 representing a type of the subsequent header, a MPLS label (LSP label) 414-1, a MPLS label (PW label) 414-2, a payload section 415, and a FCS 416.

The MPLS labels 414-1 and 414-2 contain a label value serving as a path identifier and a TC value representing a priority.

The payload section 415 can be classified into a case where the Ethernet packet of the communication packet 40 of FIG. 4 is encapsulated and a case where information on the OAM generated by each communication device ND#n is stored. This format has a two-layered MPLS label. The first-layer MPLS label (LSP label) 414-1 is an identifier for identifying a path in the network NW, and the second-layer MPLS label (PW label) 414-2 is used to identify a user packet or an OAM packet. Here, if the label value of the second-layer MPLS label 414-2 has a reserved value such as “13,” the second-layer MPLS label 414-2 is the OAM packet. Otherwise, the second-layer MPLS label 414-2 is the user packet (the Ether packet of the communication packet 40 is encapsulated into the payload 415).

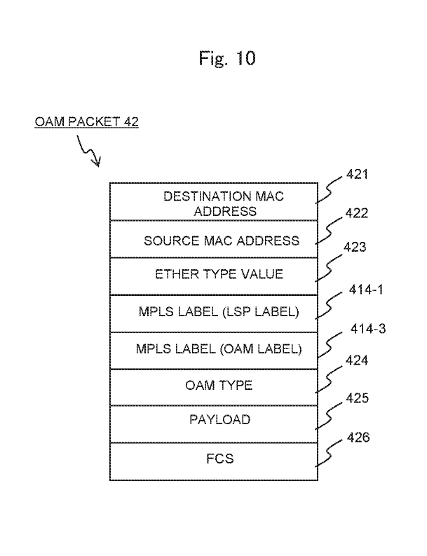

FIG. 10 illustrates a format of the OAM packet 42 transmitted or received by the communication device ND#n in the network NW.

The OAM packet 42 includes a destination MAC address 421, a source MAC address 422, a MAC header containing a type value 423 representing a type of the subsequent header, a first-layer MPLS label (LSP label) 414-1 similar to that of the communication packet 41, a second-layer MPLS label (OAM label) 414-3, an OAM type 424, a payload 425, and a FCS 426.

As described above, in the case of the second-layer MPLS label (OAM label) 414-3, the label value of the second-layer MPLS label (PW label) of FIG. 9 has a reserved value such as “13.” Although it is called the OAM label in this case, it is similar to the second-layer MPLS label (PW label) 414-2 except for the label value. In addition, the OAM type 424 is an identifier representing a type of the OAM packet. According to this embodiment, the CAM type 424 specifies an identifier of the failure monitoring packet or the loopback test packet (including a loopback request packet or a loopback response packet). The payload 425 specifies information dedicated to the OAM. According to this embodiment, in the case of the failure monitoring packet, the payload 425 specifies the endpoint node ID. In the case of the loopback request packet, the payload 425 specifies the loopback device ID. In the case of the loopback response packet, the payload 425 specifies the endpoint node ID.

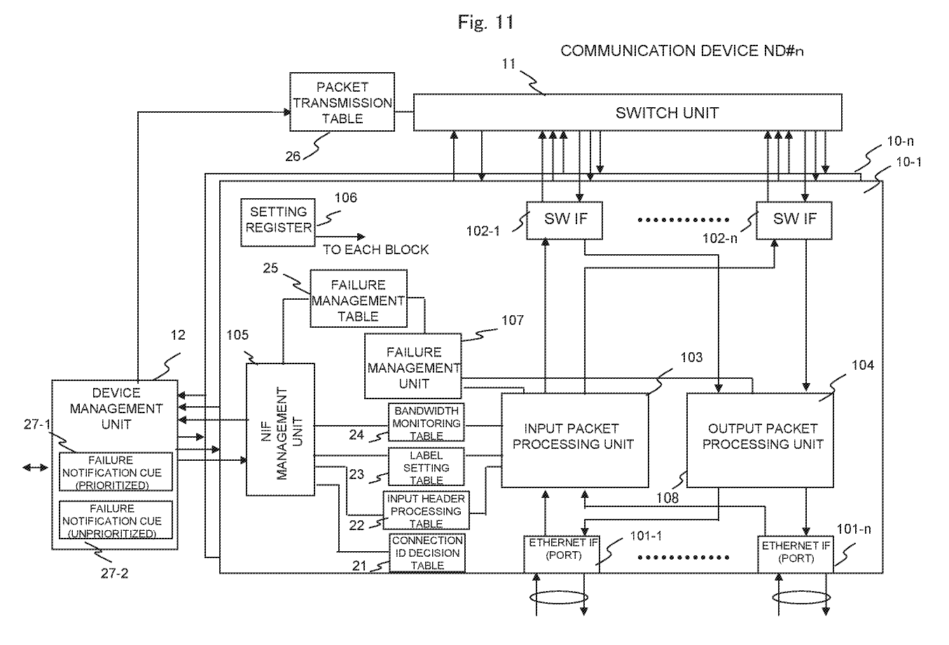

FIG. 11 illustrates a configuration of the communication device ND#n. The communication device ND#n includes a plurality network interface boards (NIF) 10 (10-1 to 10-n), a switch unit connected to such an NIF, and a device management unit 12 that manages the entire device.

Each NIF 10 has plurality of input/output network interfaces 101 (101-1 to 101-n) serving as communication ports and is connected to other devices through these communication ports. According to this embodiment, the input/output network interface 101 is an Ethernet network interface. Note that the input/output network interface 101 is not limited to the Ethernet network interface.

Each NIF 10-n has an input packet processing unit 103 connected to the input/output network interface 101, a plurality of SW interfaces 102 (102-1 to 102-n) connected to the switch unit 11, an output packet processing unit 104 connected to the SW interfaces, a failure management unit 107 that performs an OAM-related processing, an NIF management unit 105 that manages the NIFs, and a setting register 106 that stores various settings.

Here, interface 102-i corresponds to the input/output network interface 101-i, and the input packet received at the input/output network interface 101-i is transmitted to the switch unit 11 through the SW interface 102-i. In addition, the output packet distributed to the SW interface 102-i from the switch unit 11 is transmitted to an output channel through the input/output network interface 101-i. For this reason, the input packet processing unit 103 and the output packet processing unit 104 have independent structures for each channel. Therefore, the packets of each channel are not mixed.

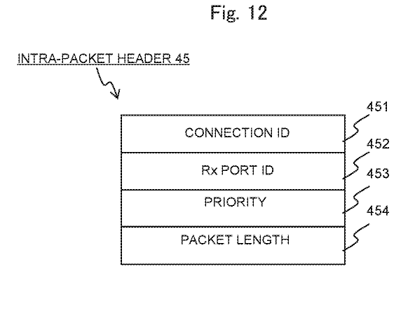

If the input/output network interface 101-i receives a communication packet 40 or from the input channel, an intra-packet header 45 of FIG. 12 is added to the received (Rx) packet.

Each table stored in the communication device ND#n and a format of the intra-packet will be described with reference to FIGS. 12 to 17.

FIG. 12 illustrates an exemplary intra-packet header 45. The intra-packet header 45 includes a plurality of fields indicating a connection ID 451, an Rx port ID 452, a priority 453, and a packet length 454.

When the input/output network interface 101-i of FIG. 11 adds the intra-packet header 45 to the Rx packet, the port ID obtained from the setting register 106 is stored in the Rx PORT ID 452, and the length of the corresponding packet is counted and store as the packet length 454. Meanwhile, the CONNECTION ID 451 and the priority 453 are blanked. In these fields, a valid value is set by the input packet processing unit 103.

The input packet processing unit 103 performs an input packet process S100 as described below in order to add the connection ID 451 and the priority 453 to the intra-packet header 45 of each input packet referring to each of the following tables 21 to 24 and perform other header processes or a bandwidth monitoring process. As a result of the packet process S100, the input packet is distributed to each channel of the SW interface 102 and is transmitted.

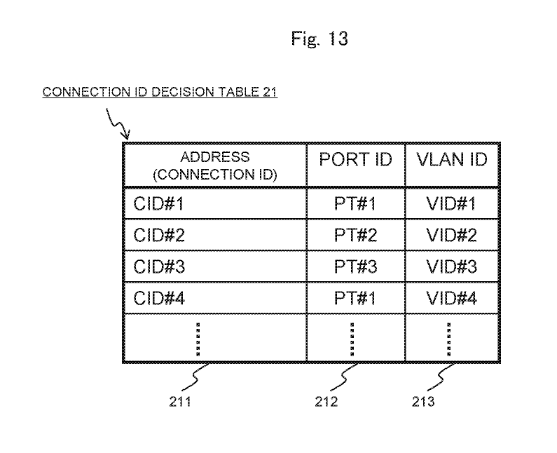

FIG. 13 illustrates connection ID decision table 21. The connection ID decision table 21 is to obtain a connection ID 211 as a registered address by using a combination of the input port ID 212 and the VLAN ID 213 as a search key. In general, this table is stored in a content-addressable memory (CAM). Here, the connection ID 211 is an identifier for specifying each connection of the corresponding communication device ND#n and uses the same ID in both directions. How to use this table will be described below in more details.

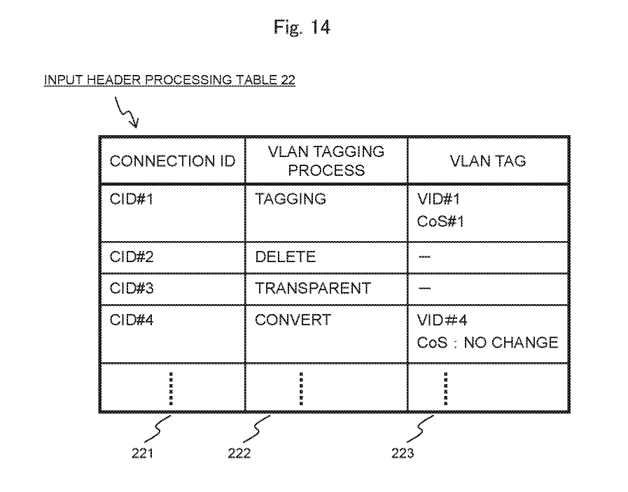

FIG. 14 illustrates an input header processing table 22. The input header processing table 22 is to search table entries indicating a VLAN tagging process 222 and a VLAN tag 223 by using the connection ID 221 as a search key. Here, in the VLAN tagging process 222, a VLAN nagging process for the input packet is selected, and tag information necessary for this purpose is set in the VLAN TAG 223. How to use this table will be described below in more details.

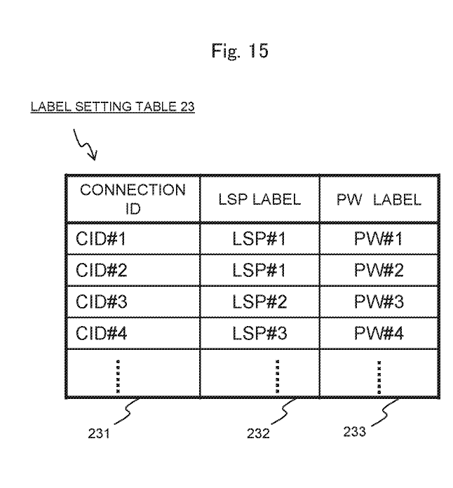

FIG. 15 illustrates a label setting table 23. The label setting table 23 is to search table entries indicating a LSP label 232 and a PW label 233 by using a connect on ID 231 as a search key. How to use this table will be described below in more details.

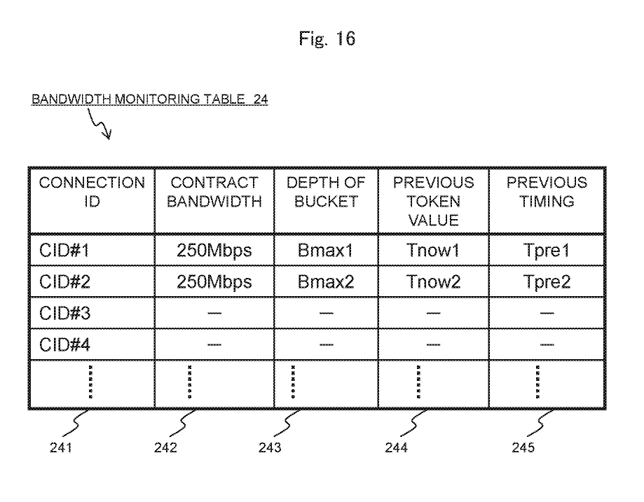

FIG. 16 illustrates a bandwidth monitoring table 24. The bandwidth monitoring table 24 is to search table entries indicating a contract bandwidth 242, a depth of bucket 243, a previous token value 244, and a previous timing 245 by using the connection ID 241 as a search key.

Here, in the case of the guarantee type service, the same value as that of the contract bandwidth set for each user is set in the contract bandwidth 242, and a typical token bucket algorithm is employed. Therefore, for a packet within the contract bandwidth, a high priority is set in the priority 453 of the intra-packet header 45, and a packet determined to exceed the contract bandwidth is discarded. In contrast, in the case of the fair distribution type service, an invalid value is set in the contract bandwidth 242, and a low priority is set in the priority 453 of the intra-packet header 45 for all packets.

The switch unit 11 receives the input packet from SW interfaces 102-1 to 102-n of each NIF and specifies the output port ID and the output label by referring to the packet transmission table 26. In addition, the packet is transmitted to the corresponding SW interface 102-i as an output packet. In this case, depending on the TC value representing a priority of the MPLS label 414-1, a packet having a higher priority is preferentially transmitted during congestion. In addition, the output label 276 is set in the MPLS label (LSP label) 414-1.

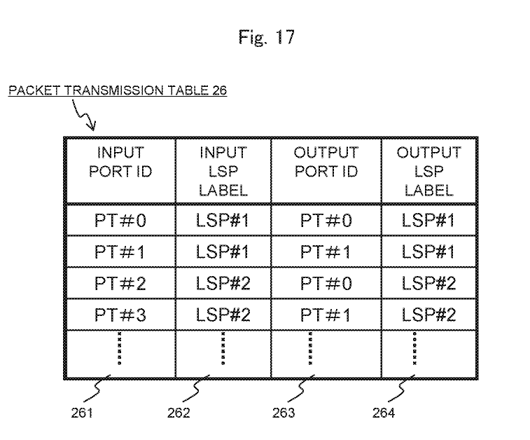

FIG. 17 illustrates a packet transmission table 26. The packet transmission table 26 is to search table entries indicating an output port ID 263 and an output LSP label 264 by using a combination of the input port ID 261 and the input LSP label 262 as a search key.

The switch unit 11 searches the packet transmission table 26 using the Rx port ID 451 of the intra-packet header 45 and the LSP ID of the MP LS label (LSP label) 414-1 of the input packet and determines an output destination.

The output packets received by each SW interface 102 are sequentially supplied to the output packet processing unit 104.

If a processing mode of the corresponding NIF 10-n in the setting register 106 is set as the Ethernet processing mode, the output packet processing unit 104 deletes the destination MAC address 411, the source MAC address 412, the type value 413, the MPLS label (LSP label) 414-1, and the MPLS label (PW label) 414-2 and outputs the packet to the corresponding input/output network interface 101-i.

Meanwhile, if the processing mode of the corresponding NIF 10-n in the setting register 106 is set as the MPLS processing mode, the packet is directly output to the corresponding input/output network interface 101-i without performing a packet processing.

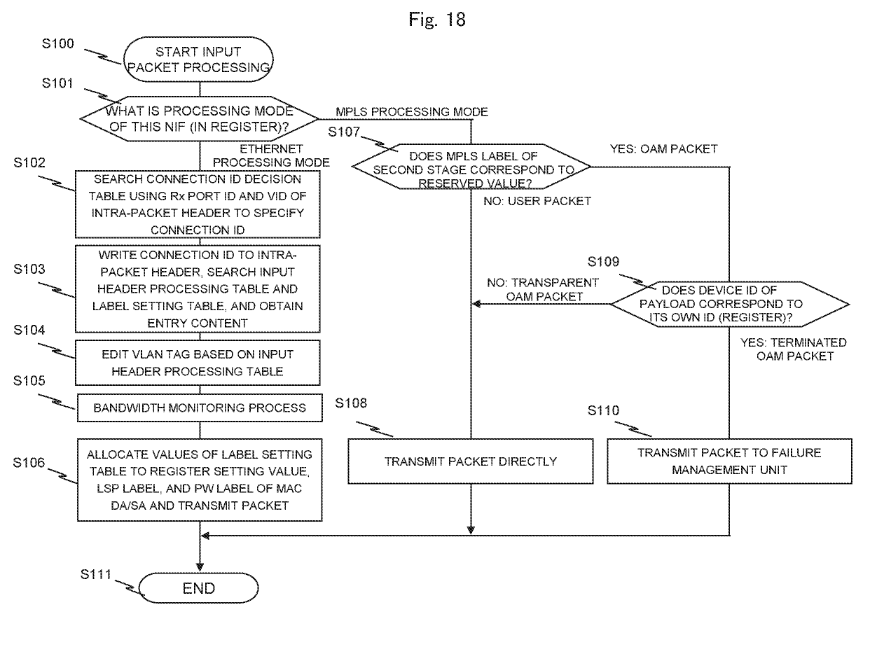

FIG. 18 is a flowchart illustrating the input packet process S100 executed by the input packet processing unit 103 of the communication device ND#n. This process can be executed when the communication device ND#n has a hardware resource such as a microcomputer, and the hardware resources are used in software information processing.

The input packet processing unit 103 determines a processing mode of the corresponding NIF 10-n set in the setting register 106 (step S101).

If the Ethernet processing mode is set, information is extracted from each of the intra-packet header 45 and the VLAN tag 403, and the connection ID decision table 21 is searched using the extracted Rx port ID 452 and VID to specify the connection ID 211 of the corresponding packet (step S102).

Then, the connection ID 211 is written to the intra-packet header 45, and the entry content is obtained. searching the input header processing table 22 and the label setting table 23 (step S103).

Then, the VLAN tag 403 is edited on the basis of the content of the input header processing table 22 (step S104).

Then, a bandwidth monitoring process is performed for each connection ID 211 (in this case, for each user), and the priority 453 of the intra-packet header 45 (FIG. 12) is added (step S105).

In the communication packet 41 (FIG. 9), the setting values of the setting register 106 are set as the destination MAC address 41 and the source MAC address 412, and a number “8847 (hexadecimal)” representing the MPLS is set as the type value 413. In addition, the LSP label 232 of the label setting table 23 is set as the MPLS label (LSP label) 414-1, and the PW label 233 of the label setting table 23 is set as the label value of the MPLS label (PW label) 414-2. Furthermore, priority 453 of the intra-packet header 45 is set as the TC value.

Then, the packet is transmitted (step S106), and the process is finished (step S111).

Meanwhile, if the MPLS processing mode is set in step S101, it is determined whether or not the second-layer MPLS label 414-2 is a reserved value “13” in the communication packet 41 (step S107). If it is not the reserved value, the corresponding packet is directly transmitted as a user packet (step S108), and the process is finished (S111).

Otherwise, if the second-layer MPLS label 414-2 is the reserved value in step S107, it is determined as the OAM packet. In addition, it is determined whether or not the device ID of the payload 425 of the corresponding packet matches its own device ID set in the setting register 106 (step S109). If they do not match each other, the packet is determined as a transparent OAM packet. Then, similar to the user packet, the processes subsequent to step S108 are executed.

Meanwhile, if they match each other in step S109, the packet is determined as an OAM packet terminated at the corresponding device, and the corresponding packet transmitted to the failure management unit 107 (step S110). Then, the process is finished (step S111).

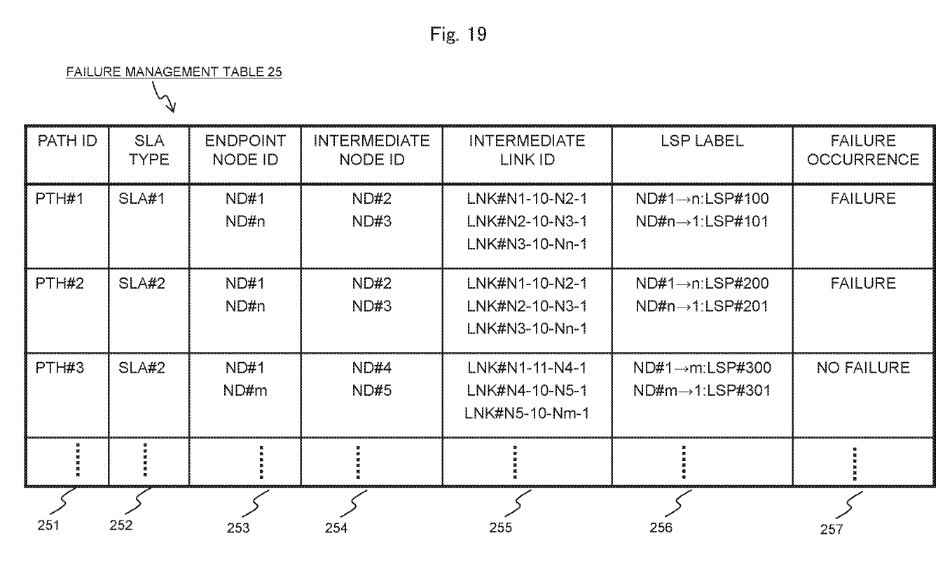

FIG. 19 illustrates a failure management table 25. The failure management table 25 is to search table entries indicating an SLA type 252, an endpoint node ID 253, an intermediate node ID 254, an intermediate link ID 255, an LSP label value 256, and a failure occurrence 257 by using a path ID 251 as a search key.

Here, the path ID 251, the SEA type 252, the endpoint node ID 253, the intermediate node ID 254, the intermediate link ID 255, and the LSP label value 256 match the path ID NMS-t41, the SLA type NMS-t42, the endpoint node ID NMS-t43, the intermediate node ID NMS-t44, the intermediate link ID NMS-t45, and the LSP label value NMS-t46, respectively, of the path configuration table NMS-t4.

The failure occurrence 257 is information representing whether or not a failure occurs in the corresponding path. The NIF management unit 105 reads the failure occurrence 257 in the failure management table polling process, determines a priority depending on the SLA type 252, and notifies the device management unit 12. The device management unit 12 determines a priority depending on the SLA type 252 of the entire device in the failure notification cue reading process S400 and finally notifies the network management system NMS of the priority. How to use this table will be described below in more details.

The failure management unit 107 periodically transmits the failure monitoring packet to the path 251 added to the failure management table 25. This failure monitoring packet contains the LSP label value 256 as the LSP label 414-1, an identifier representing the failure monitoring packet as the OAM type 424, an opposite endpoint node ID ND#n in the payload 425, and the setting value of the setting register 106 in other areas (refer to FIG. 10). If a failure monitoring packet is not received from the corresponding path for a predetermined period of time, the failure management unit 107 specifies “FAILURE” that represents a failure occurrence in the FAILURE OCCURRENCE 256 of the failure management table 25.

If an OAM packet destined to itself is received from the input packet processing unit 103, the failure management unit 107 checks the OAM type 424 of the payload 425 and determines whether the corresponding packet is a failure monitoring packet or a loopback test packet (loopback request packet or loopback response packet). If the corresponding packet is the failure monitoring packet, “NO FAILURE” that represents failure recovery is specified in the FAILURE OCCURRENCE 256 of the failure management table 25.

In order to perform the loopback test for the path specified by the network management system in the loopback test described below, the failure management unit 107 generates and transmits a loopback request packet by setting the LSP label 256 of the test target path ID NMS-t41 specified by the network management system as the ISP label 414-1 as described below, setting the identifier that represents that this packet is the loopback request packet in the OAM type 424, setting the intermediate node ID NMS-t44 serving as the loopback target in the payload 425, and setting the setting values of the setting register 106 in other areas.

If the CAM packet destined to itself is received from the input packet processing unit 103, the failure management unit 107 checks the CAM type 424 of the payload 425. If the received packet is determined as the loopback request packet, a loopback response packet is returned by setting the LSP label value 256 having a direction opposite to the receiving direction as the LSP label 414-1, setting an identifier that represents the loopback response packet in the OAM type 424, setting the endpoint node ID 253 serving as a loopback target in the payload 425, and setting the setting values of the setting register 106 in other areas.

Otherwise, if the received packet is determined as the loopback response packet, the loopback best is successful. Therefore, this is notified to the network management system NMS through the NIF management unit 105 and the device management unit 12.

FIG. 20 illustrates a sequence SQ100 for setting the network NW from an operator OP.

As a setting change, an operator OP transmits a requested type of this change (newly adding or deleting a user, that is, if the setting is changed, an operator adds a new user after deleting an existing user), a user ID, an access point (for example, a combination or the access unit #1 and the data center DC), a service type, and a changed contract bandwidth (sequence SQ101).

As the network management system NMS receives the setting change, the network management system NMS changes a path establishment policy depending on the SLA of the service by referring to tale path establishment policy table NMS-t1 or like through a service-based path search process S2000 described below. In addition, the network management system NMS searches path using the access point management table NMS-t3 or the link management table NMS-t5. A result thereof is set in the communication devices ND#1 to ND#n (sequences SQ102-1 to SQ102-n).

This setting information includes a path connection relationship or a bandwidth setting for each user, such as the connection ID decision table 21, the input header processing table 22, the label setting table 23, the bandwidth monitoring table 24, the failure management table 25, and the packet transmission table 26 described above. If this information is set in each communication device ND#n, traffics from a user can be transmitted or received along the established route. In addition, the failure monitoring packet starts to be periodically transmitted or received between the edge devices ND#1 and ND#n serving as endpoints of the path (sequences SQ103-1 and SQ103-n).

Through the aforementioned process, a desired setting is completed. Therefore, a setting completion notification is transmitted from the network management system NMS an operator OP (sequence SQ104), and this sequence is finished.

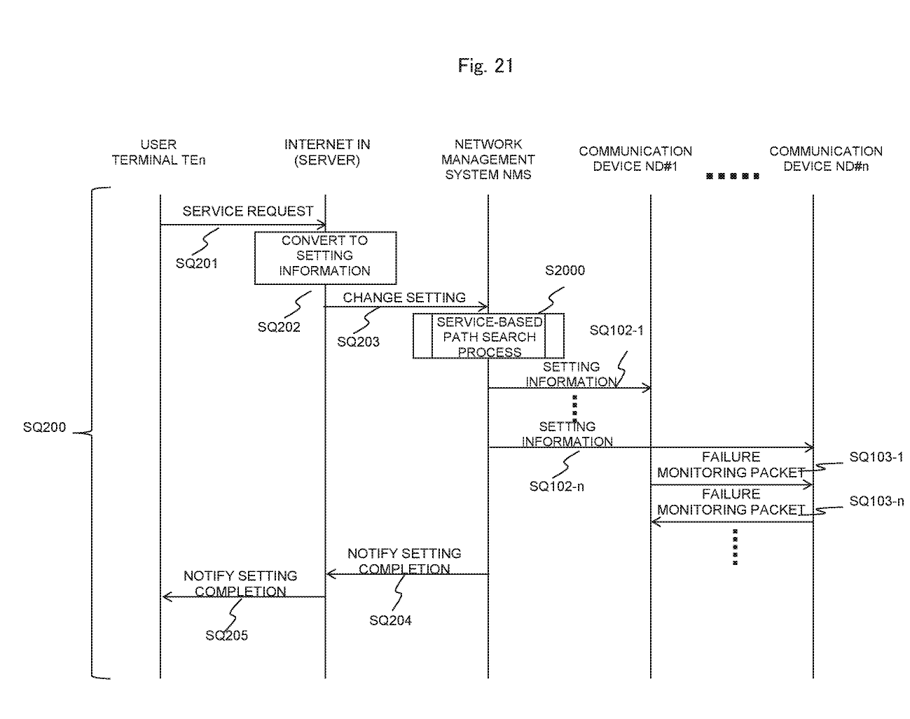

FIG. 21 illustrates a sequence SQ200 for setting the network NW in response to a request from the user terminal TEn.

Here, it is assumed that a server used to provide a homepage or the like by the communication service provider as a means for allowing the communication service provider to receive a service request that necessitates a change of the network NW from a user is installed in the Internet IN. If a user does not have connectivity to the Internet IN in this network NW, it is assumed that the user has a means capable of accessing the Internet using another alternative means, such as a mobile phone, or from any one provided in home or offices.

If a service request is generated from a user terminal TEn (sequence SQ201), a server that receives the service request in Internet IN converts it into setting information of the network NW (sequence SQ202) and transmits a change of this setting to the network management system NMS through the management network MNW (sequence SQ203).

The subsequent processes such as the service-based path search process S2000, setting to the communication device ND#n. (sequence SQ102), and the process of all monitoring start (sequence SQ103) using a monitoring packet are similar to those of the sequence SQ100 (FIG. 20). Since a desired setting is completed through the aforementioned processes, a setting completion notification transmitted from the network management system NMS to the server on the Internet IN through the management network MNW (sequence SQ104) and is further notified to the user terminal TEn (sequence SQ205). Then, this sequence is finished.

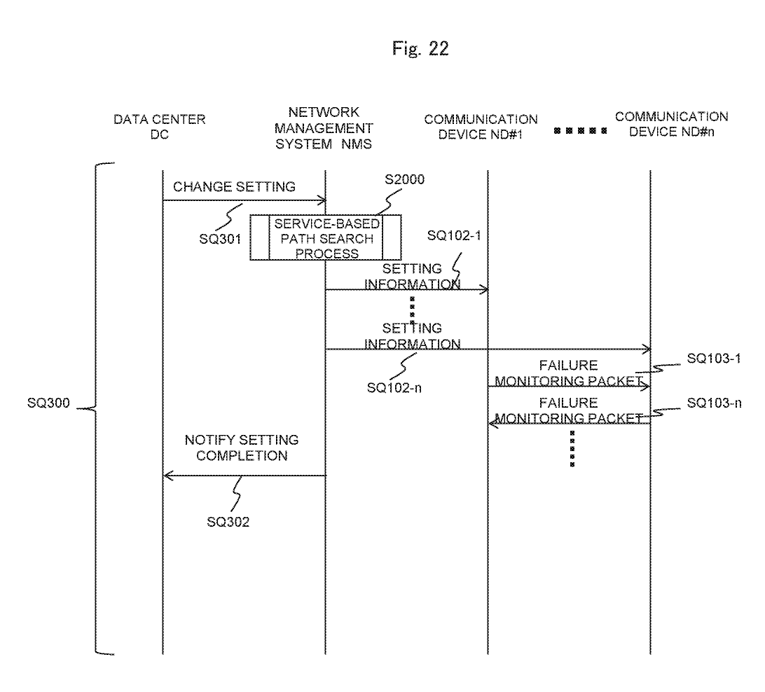

FIG. 22 illustrates a sequence SQ300 for setting the network NW in response to a request from the data center DC.

If a request for the setting change is transmitted from the data center DC through the management network MNW (sequence SQ301), this setting change is processed.

The subsequent processes such as the service-based path search process S2000, setting to the communication device ND#n. (sequence SQ102), and the process of all-time monitoring start (sequence SQ103) using a monitoring packet are similar to those of the sequence SQ100 (FIG. 20).

Since a desired setting is completed through the aforementioned processes, a setting completion notification is notified from the network management system NMS to the data center DC through the management network MNW (sequence SQ302), and this sequence is finished.

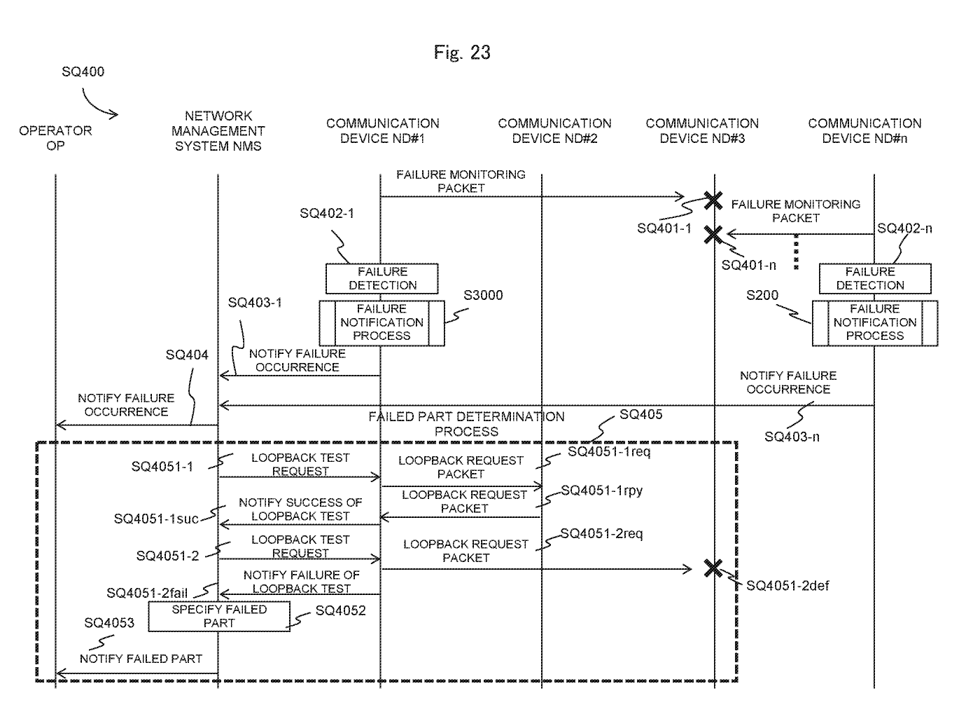

FIG. 23 illustrates a failure portion specifying sequence SQ400 when a failure occurs in the repeater ND#3.

If a failure such as a communication interrupt occurs in the repeater ND#3, the failure monitoring packet periodically transmitted or received between the edge devices ND#1 and ND#n does not arrive (sequences SQ401-1 and SQ401-n).

As a result, each edge device ND#1 and ND#n detects failure occurring in the path PTH#1 of she guarantee type service (sequences SQ402-1 and SQ402-n).

As a result, each edge device ND#1 and ND#n performs a failure notification process S3000 described below to preferentially notify the network management system NMS of the failure in the path PTH#1 of the guarantee type service (sequences SQ403-1 and SQ403-n).

The network management system NMS that receives this notification notifies an operator OP of the fact that a failure occurs in the path PTH#1 of the guarantee type service (sequence SQ404) and automatically executes the following failure portion determination process (sequence SQ405).

First, the network management system NMS notifies the edge device ND#1 of a loopback test request and necessary information (such as the test target path ID NMS-t41 and the intermediate node ID NMS-t44 serving as a loopback target) in order to check normality between the edge device ND#1 and its neighboring repeater ND#2 (sequence SQ4051-1).

As this request is received, the edge device ND#1 transmits the loopback request packet as described above (sequence SQ4051-1req).

The repeater ND#2 that receives this loopback test packet returns the loopback response packet as described above because this is the loopback test destined to itself (sequence SQ4051-1rpy).

The edge device ND#1 that receives this loopback response packet notifies the network management system NMS of a loopback test success notification (sequence SQ4051-1suc).

The network management system NMS that receives this loopback test success notification notifies the edge device ND#1 of the loopback test request and necessary information in order to specify the failure portion and check normality with the repeater ND#3 (sequence SQ4051-2).

As this request is received, the edge device ND#1 transmits the loopback request packet as described above (sequence SQ4051-2req).

Since the repeater ND#3 is failed, this loopback test packet is not returned to the edge device ND#1 (sequence SQ4051-2def).

Since the loopback response packet is not returned within a predetermined period of time, the edge device ND#1 notifies the network management system NMS of a loopback test failure notification (sequence SQ4051-2fail).

The network management system NMS that receives this loopback test failure notification specifies the failure portion as the repeater ND#3 (sequence SQ4052) and notifies an operator OP of this information as the failure portion (sequence SQ4053). Then, this sequence is finished.

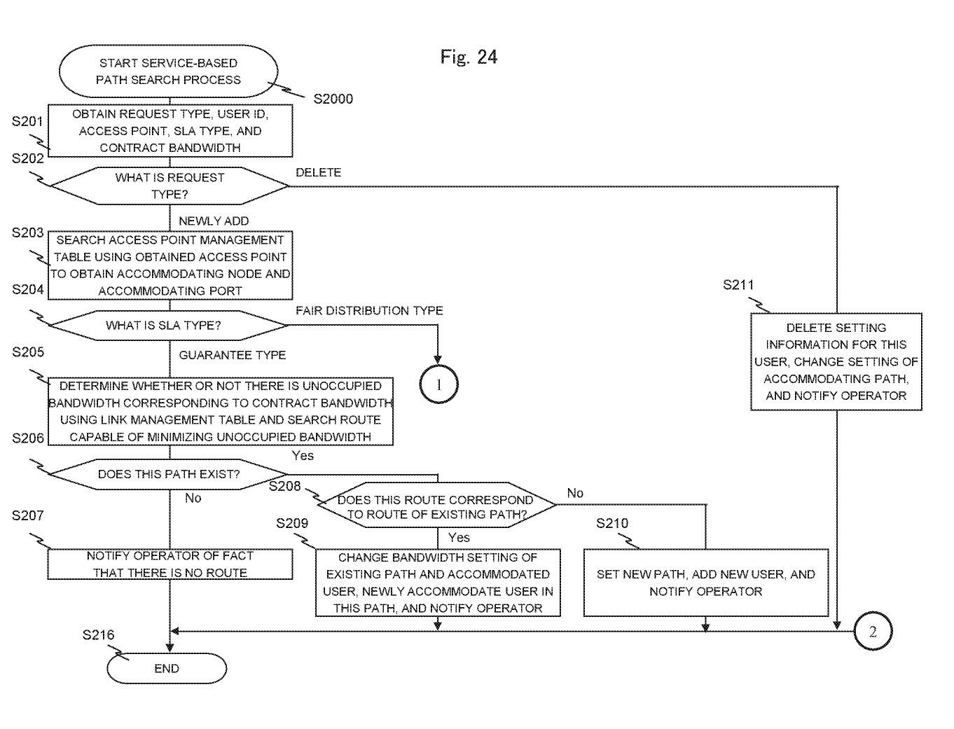

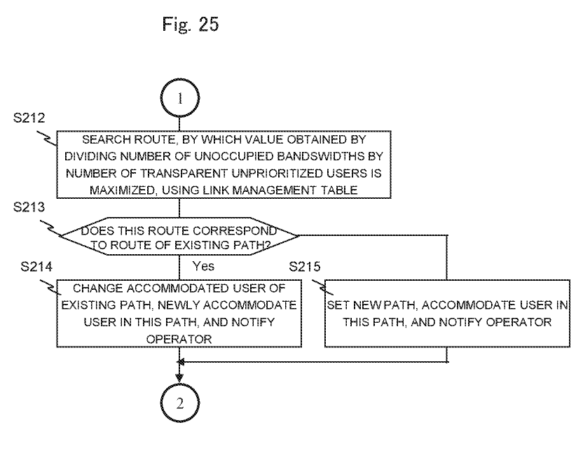

FIGS. 24 and 25 illustrate the service-based path search process S2000 executed by the network management system NMS. This process can be implemented when the network management system NMS has the hardware resources illustrated in FIG. 2, and the hardware resources are used in software information processing.

The network management system NMS that receives the setting change from an operator OP, the Internet IN, or the data center DC obtains a requested type, an access point, an SLA type, and a contract bandwidth as the setting change (step S201) and checks the obtained requested type (step S202).

If the requested type is “DELETE,” the corresponding entry is deleted from the corresponding user management table NMS-t2 (FIG. 4), and information on entries of the path configuration table NMS-t4 (FIG. 6) corresponding to the path NMS-t23 that accommodates the corresponding user is updated.

If the update content is the guarantee type service, the contract bandwidth NMS-t24 of the user management table NMS-t2 (FIG. 4) is subtracted from the allocated bandwidth NMS-t47 of the path configuration table NMS-t4 (FIG. 6), and the corresponding user ID is deleted from the ACCOMMODATED USER NMS-t48. Otherwise, if the update content is the fair distribution type service, the corresponding user ID is deleted from the ACCOMMODATED USER NMS-t48.

In the link management table NMS-t5 (FIG. 7), all of the entries corresponding to the intermediate link ID NMS-t45 of the path configuration table NMS-t4 (FIG. 6) are updated. If the update content is the guarantee type service, the contract bandwidth NMS-t24 is subtracted from the unoccupied bandwidth NMS-t52. If the update content is the fair distribution type service, the number of transparent unprioritized users NMS-t53 is decremented. In addition, various tables 21 to 26 of the corresponding communication device ND#n are updated, and the processing result is notified to an operator (step S211). Then, the process is finished (step S216).

If a user is newly added in step S202, the access point management table NMS-t3 (FIG. 5) is searched using information on the corresponding access point to extract candidate combinations of the accommodating unit (node) ID NMS-t33 and the accommodating port ID NMS-t34 as a point capable of serving as an access point (step S203). For example, if the access unit AE#1 is selected as a start point, and the data center DC is selected as an endpoint in FIG. 1, the candidate may be determined as follows.

Start Point Port Candidate:

(1) the accommodating port ID PT#1 of the accommodating unit ID ND#1.

Endpoint Port Candidate:

(A) the accommodating port ID PT#10 of the accommodating unit ID ND#n; and

(B) the accommodating port ID PT#11 of the accommodating unit ID ND#n.

Here, this means that it is necessary to search a path between the start point port candidate and the endpoint port candidate. That is, in this case, the path between (1) and (A) and the path between (1) and (B) become the candidates.

Subsequently, the SLA type obtained in step S201 is checked (step S204). If the SLA type is the guarantee type service, it is checked whether or not there is an unoccupied bandwidth corresponding to the selected contract bandwidth, and a route by which the unoccupied bandwidth is minimized is searched using the link management table NMS-t5 (FIG. 7) on the basis of a general route tracing algorithm (such as multi-path route selection scheme or a Dijkstra's algorithm) (step S205). Specifically, assuming that there are some routes extending from the start point port to the endpoint port, for example, via a link determined as being available from the link management table NMS-t5, a route having a minimum sum of the cost (in this embodiment, the unoccupied bandwidth) may be selected out of these routes. As a result, it is possible to consolidate the paths of the guarantee type service into an existing path. Alternatively, instead of the route having the minimum sum of the cost, one of the routes having costs equal to or lower than a predetermined threshold may be randomly selected. Similarly, in this case, it is possible to obtain the consolidating effect at some extent. The threshold may be set by defining an absolute value or a relative value (for example, 10% or lower).

Subsequently, it is determined whether or not there is a route satisfying the condition as a result of step S205 (step S206).

If there is no such a route as a result of the determination, an operator is notified of the fact that there is no route (step S207). Then, the process is finished (step S216).

Meanwhile, if there is such a route in step S206, it is determined whether or not this route is a route of the existing path using the path configuration table NMS-t4 (step S208).

If this route is a route of the existing path, a new entry is added to the user management table NMS-t2, and the existing path is set as the accommodating path NMS-t23. In addition, information on the corresponding entry of the path configuration table NMS-t4 is updated (the contract bandwidth NMS-t24 is added to the ALLOCATED BANDWIDTH NMS-t47, and the new user ID added to the ACCOMMODATED USER NMS-t48). Furthermore, all of the entries corresponding to the intermediate link ID NMS-t45 in the link management table NMS-t5 are updated (the contract bandwidth NMS-t24 is added to the UNOCCUPIED BANDWIDTH NMS-t52). Moreover, various tables 21 to 26 of the corresponding communication device ND#n are updated, and the processing result is notified to an operator (step S209). Then, the process is finished (step S216).

Meanwhile, if this route is not a route of the existing path in step S208, a new entry is added to the user management table NMS-t2, and a new path is established as accommodating path NMS-t23. In addition, a new entry is added to the path configuration table NMS-t4 (the contract bandwidth NMS-t24 is set in the allocated bandwidth NMS-t47, and the new user ID is added to the ACCOMMODATED USER NMS-t48). Furthermore, all of the entries corresponding to the intermediate link ID NMS-t45 in the Link management table NMS-t5 are updated (the contract bandwidth NMS-t24 is added to the UNOCCUPIED BANDWIDTH NMS-t52). Moreover, various tables 21 to 26 of the corresponding communication device ND#n are updated, and the processing result is notified to an operator (step S210). Then, the process is finished (step S216).

Through the aforementioned processes, in the guarantee type service, a plurality of communication paths of the routes having the same source port and the same destination port on the communication network are consolidated as illustrated as the path PTH#1 in FIG. 1. In this case, it would be ideal if the routes having the same source port and the same destination port on the network between edge devices ND#1 and ND#n can be consolidated as illustrated in FIG. 1. Alternatively, only a part of the routes between the edges may also be consolidated. By consolidating the communication paths of the guarantee type service, it is possible to narrow a physical range of the important maintenance target. Therefore, it is possible to concentrate resources for maintenance/inspection works on that range.

FIG. 25 illustrates a process performed when it is determined that the SLA type is the fair distribution type service in step S204. If the SLA type is determined as the fair distribution type service in step S204, a route by which the “value obtained by dividing the unoccupied bandwidth NMS-t52 by the number of transparent unprioritized users NMS-t53” is maximized is searched using the link management table NMS-t5 on the basis of a general route tracing algorithm (such as a multi-path route selection scheme or a Dijkstra's algorithm) (step S212).

Specifically, assuming that there are some routes extending from the start point port to the endpoint port, for example, via the link determined as being available from the link management table NMS-t5, one of such routes having the maximum sum of the cost (in this embodiment, “value obtained by dividing the unoccupied bandwidth NMS-t52 by the number of transparent unprioritized users NMS-t53”) is selected. As a result, the traffic of the fair distribution type service is distributed across the existing paths. Alternatively, instead the route having the maximum value, one of the routes having the value equal to or lower than a predetermined threshold may be randomly selected. Similarly, in this case, it is possible to obtain the distributing effect at some extent. The threshold may be set by defining an absolute value or a relative value (for example, 10% or lower).

Subsequently, after step S212, it is determined whether or not the obtained route is a route of the existing path using the path configuration table NMS-t4 (step S213).

If the obtained route is the route of the existing path, a new entry is added to the user management table NMS-t2, the existing path is established as the accommodating path NMS-t23, and information on the entries in the corresponding path configuration table NMS-t4 is updated. Specifically, a new user ID is added to the ACCOMMODATED USER NMS-t48. In addition, all of the entries corresponding to the intermediate link ID NMS-t45 in the link management table NMS-t5 are updated. Specifically, the number of transparent unprioritized users NMS-t53 is incremented. Furthermore, various tables 21 to 26 of the corresponding communication device ND#n are updated, and the processing result is notified to an operator (step S214). Then, the process is finished (step S216).

Otherwise, if the obtained route is not the route of the existing path in step S213, a new entry is added to the user management table NMS-t2, and the new path is established as the accommodating path NMS-t73. In addition, a new entry is added to the path configuration table NMS-t4. Specifically, a new user ID is added to the ACCOMMODATED USER NMS-t48. In addition, all of the entries corresponding to the intermediate link ID NMS-t45 in the link management table NMS-t5 are updated. Specifically, the number of transparent unprioritized users NMS-t53 is incremented. Furthermore, various tables 21 to 26 of the communication device ND#n are updated, and the processing result is notified to an operator (step S215). Then, the process is finished (step S216).

Through the aforementioned processes, in the fair distribution type service, the communication paths are distributedly arranged in the unoccupied bandwidth of the guarantee type service as indicated by the paths PTH#2 and PTH#n in FIG. 1.

In this manner, the paths of the guarantee type service can be consolidated in the same route, and the paths of the fair distribution type service can be distributed depending on a ratio of the number of the accommodated users.

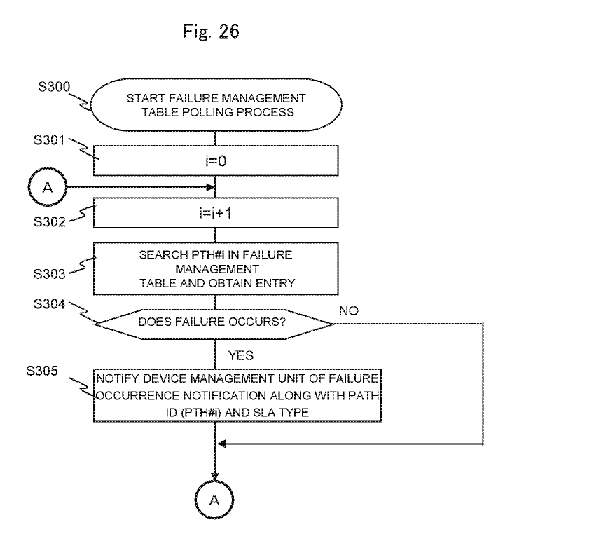

FIG. 26 illustrates a failure management table polling process S300 in the failure notification process S3000 (FIG. 23) executed by the NIF management unit 105 of the communication device ND#n in details.

As a device is powered on, the NIF management unit 105 starts this polling process, so that a variable “i” is initialized to zero (step S301), and the variable is incremented (step S302).

Then, the path ID 251 of PTH#i is searched in the failure management table 25 (FIG. 19), and the entry is obtained (step S303).

Then, the FAILURE OCCURRENCE 257 (FIG. 19) of the corresponding entry is checked (step S304).

If the FAILURE OCCURRENCE 251 is set to “FAILURE,” “PTH#i” is set as the path ID, and the SLA type 252 (FIG. 19) notified to the device management unit 12 as a failure occurrence notification (step S305). Then, the process subsequent to step S302 is continued.

Otherwise, in the step S304, if the FAILURE OCCURRENCE 257 is set to “NO FAILURE,” the process subsequent to step S302 is continued.

If the SLA type is the guarantee type service (for example, SLA#1), the device management unit 12 that receives the aforementioned failure occurrence notification stores the received information in the failure notification cue (prioritized) 27-1. If the SLA type is the fair distribution type service (for example, SLA#2), the received information is stored in the failure notification cue (unprioritized) 27-2 (refer to FIG. 11).

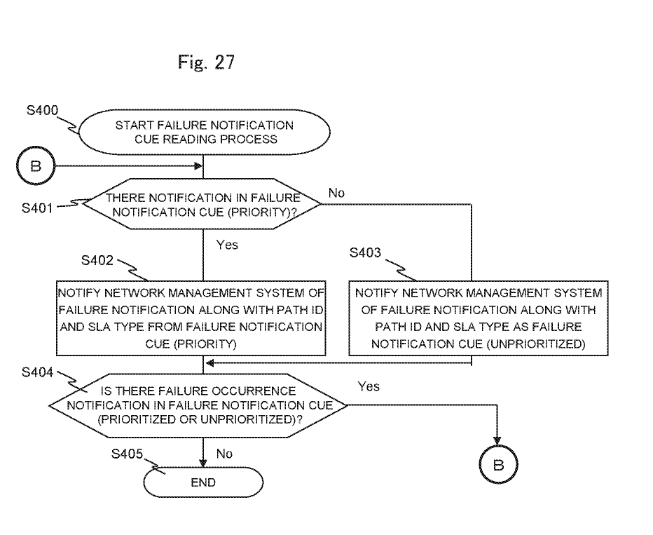

FIG. 27 illustrates a failure notification cue reading process S400 in the failure notification process S3000 executed by the device management unit 12 of the communication device ND#n in details.

If it is determined that the failure occurrence notification is stored in any of the failure notification cue (prioritized) 27-1 or the failure notification cue (unprioritized) 27-2, the device management unit 12 determines whether or not there is a notification in the failure notification cue (prioritized) 27-1 (step S401).

If there is a notification in the failure notification cue (prioritized) 27-1, the stored path ID and SLA type are notified from the failure notification cue (prioritized) 27-1 to the network management system NMS as a failure notification (step S402).

Then, it is determined whether or not the failure occurrence notification is stored in any of the failure notification cue (prioritized) 27-1 or the failure notification cue (unprioritized) 27-2 (step S404). If there is no failure occurrence notification in both cues, the process is finished (step S405).

Otherwise, if it is determined that there is no notification in the failure notification cue (prioritized) 27-1 in step S401, the stored path ID and the SLA type are notified from the failure notification cue (unprioritized) 27-2 to the network management system NMS as a failure notification (step S403). Then, the process subsequent to step S404 is executed.

Otherwise, if there is a notification in any one in step S404, the process subsequent to step S401 is continued.

Through the aforementioned processes S300 and S400, the failure notification of the guarantee type service detected by each communication device can be preferentially notified to the network management system NMS. The network management system NMS can preferentially respond to the guarantee type service and easily guarantee the availability factor by preferentially treating the failure on a first-come-first-serviced manner.

### Embodiment 2

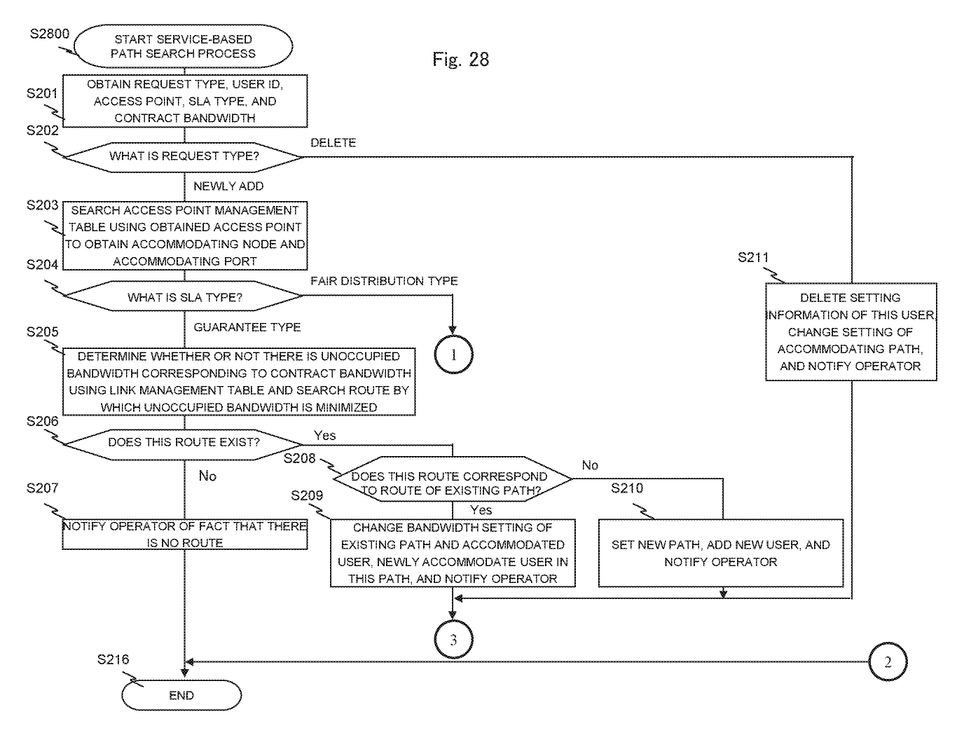

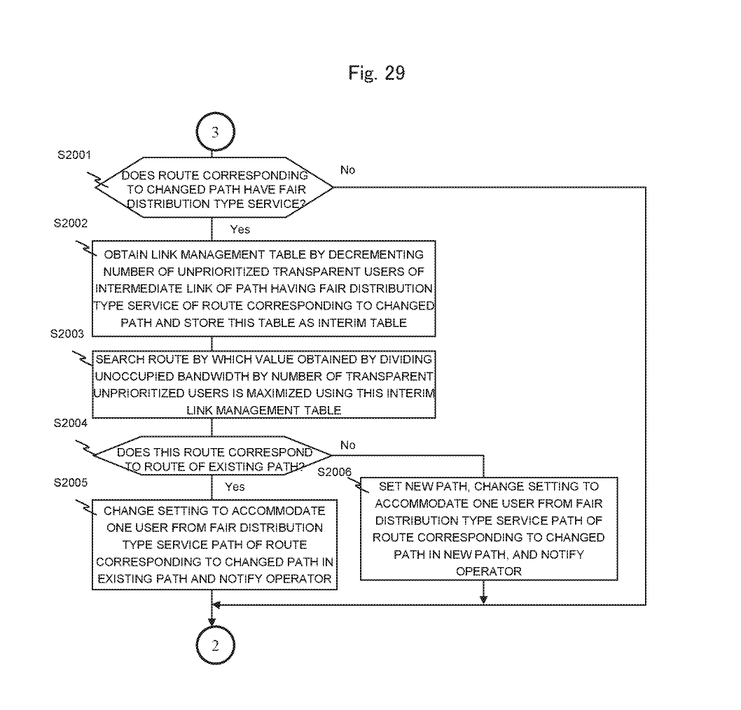

FIGS. 28 and 29 illustrate a service-based path search process S2800 executed by the network management system NMS according to another embodiment of the invention. Processes other than step S2800 are similar to those of Embodiment 1.

Step S2800 is different from step S2000 (FIG. 24) in that steps S2001 to S2006 are added after steps S209, S210, and S211 as described below. Since other processes are similar to those of step S2000, only differences will be described below.

Whether or not there is a path of the fair distribution type service in the same route as that of the path whose setting is changed as a result of steps S209, S210, and S211 is searched from the path configuration table NMS-t4 (step S2001).

If there is a path of the fair distribution type service, the path ID NMS-t41 of the fair distribution type service of the path having the same intermediate link ID NMS-t45 is obtained. In addition, the number of transparent unprioritized users NMS-t53 corresponding to the intermediate link NMS-t45 of the corresponding path in the link management table NMS-t5 is decremented, and the link management table NMS-t5 is stored as an interim link management table (step S2002).

Then, a route by which the “value obtained by dividing the unoccupied bandwidth NMS-t52 by the number of transparent unprioritized users NMS-t53” is maximized is searched using this interim link management table NMS-t5 on the basis of a general route tracing algorithm (such as a multi-path route selection scheme or a Dijkstra's algorithm) (step S2003).

Specifically, assuming that there are some routes extending from the start point port to the endpoint port, for example, via the link determined as being available from the interim link management table NMS-t5, one of such routes having the maximum sum of the cost (in this embodiment, “value obtained by dividing the unoccupied bandwidth NMS-t52 by the number of transparent unprioritized users NMS-t53”) is selected. As a result, the traffic of the fair distribution type service is distributed over the existing paths.

Subsequently, after step S2003, it is determined whether or not the obtained route is a route of the existing path using the path configuration table NMS-t4 (step S2004).

If the obtained route is a route of the existing path, one of the users is selected from the paths of the fair distribution type service in the same route as that of the path whose setting is changed as a result of the process of steps S209, S210, and S211, and accommodation is changed to the path searched as a result of step S2003 (step S2005).

Specifically, the corresponding entry is deleted from the corresponding user management table NMS-t2, and the entry information of the path configuration table NMS-t4 corresponding to the accommodating path NMS-t23 of this user is updated (this user ID is deleted from the ACCOMMODATED USER NMS-t48). In addition, all of the entries corresponding to the intermediate link ID NMS-t45 in the link management table NMS-t5 are updated (the number of transparent unprioritized users NMS-t53 is decremented). In addition, various tables 21 to 26 of the corresponding communication device ND#n are updated. In addition, the user deleted as described above is added to the user management table NMS-t2, and the existing path is set as the accommodating path NMS-t23. In addition, the entry information of the corresponding path configuration table NMS-t4 is updated (the user ID deleted as described above is added to the ACCOMMODATED USER NMS-t48). In addition, all of the entries corresponding to the intermediate link ID NMS-t45 in the link management table NMS-t5 are updated (the number of transparent unprioritized users NMS-t53 is incremented). In addition, various tables 21 to 26 of the corresponding communication device ND#n are updated, and the processing result is notified to an operator.

Subsequently, after step S2005, the process is finished (step S216).

Otherwise, if the obtained route is not the route of the existing path, one of the users in the path of the fair distribution type service in the same route as that of the path whose setting is changed as a result of steps S209, S210, and S211 is selected, and a new path is established, so that accommodation of this path is changed (step S2006).

Specifically, the corresponding entry is deleted from the corresponding user management table NMS-t2, and the entry information of the path configuration table NMS-t4 corresponding to the accommodating path NMS-t23 of this user is updated. Specifically, this user ID is deleted from the ACCOMMODATED USER NMS-t48. In addition, all of the entries corresponding to the intermediate link ID NMS-t45 in the link management table NMS-t5 are updated. Specifically, the number of transparent unprioritized users NMS-t53 is decremented. In addition, various tables 21 to 26 of the corresponding communication device ND#n are updated. In addition, the user deleted as described above is added to the user management table NMS-t2, and the new path is set as the accommodating path NMS-t23. In addition, an entry is newly added to the path configuration table NMS-t4. Specifically, the user ID deleted as described above is added to the ACCOMMODATED USER NMS-t48. In addition, all of the entries corresponding to the intermediate link ID NMS-t45 in the link management table NMS-t5 are updated. Specifically, the number of unprioritized users NMS-t53 is incremented. In addition, various tables 21 to 26 of the corresponding communication device ND#n are updated, and the processing result is notified to an operator.

Subsequently, after step S2006, the process is finished (step S216).

Meanwhile, if there is no path of the fair distribution type service in the same route as that of the path whose setting is changed as a result of steps S209, S210, and S211, the process is finished (step S216).

Through the aforementioned processes, it is possible to evenly maintain a ratio of the unoccupied bandwidths distributed to the fair distribution type service users at all times depending on a change of the guarantee bandwidth of the guarantee type service or a change of the number of the fair distribution type service users.

### Embodiment 3

A network management system according to another embodiment of the present invention will be described.

A configuration of the network management system according to this embodiment is similar to that of the network management system NMS according to Embodiment 1 of FIG. 2. Focusing on their differences, a path is established in the path configuration table NMS-t4 in advance. For this reason, according to this embodiment, the path configuration table will be given reference numeral NMS-t40. Configurations of other blocks are similar to those of the network management system NMS.

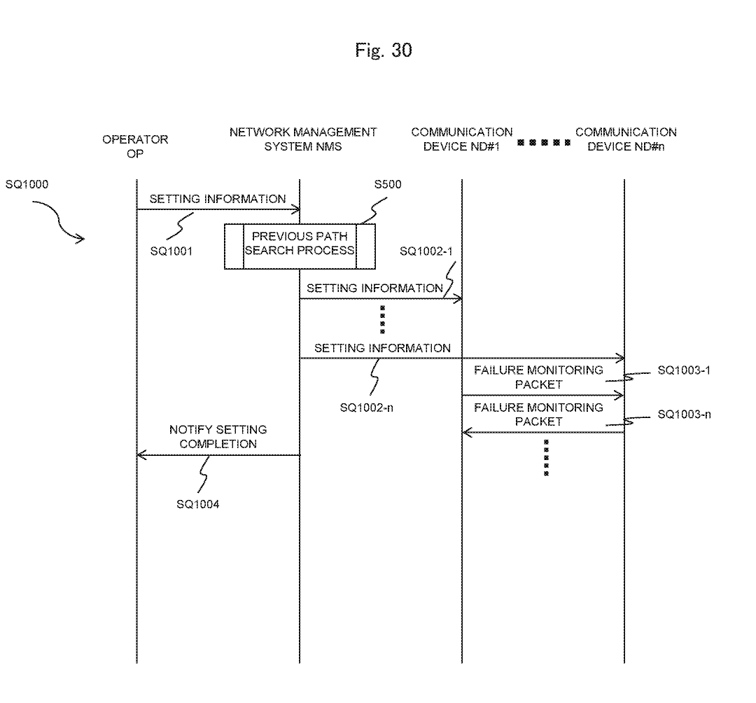

FIG. 30 illustrates a network presetting sequence SQ1000 from an operator.

An operator OP transmits presetting information such as an access point (for example, a combination of the access unit #1 and the data center DC) and a service type (sequence SQ1001).

The network management system NMS that receives she presetting information searches a path using the access point management table NMS-t3 or the link management table NMS-t5 through a preliminary path search process S500 described below. A result thereof is set in the corresponding communication devices ND#1 to ND#n (sequence SQ1002-1 to SQ1002-n).

Similar to Embodiment 1, this setting information includes a path connection relationship or a bandwidth setting for each user, such as the connection ID decision table 21, the input header processing table 22, the label setting table 23, the bandwidth monitoring table 24, the failure management table 25, and the packet transmission table 26 described above.

If this information is set in each communication device ND#n, a failure monitoring packet starts to be periodical transmitted or received between the edge devices ND#1 and ND#n serving as endpoints of the path (sequences SQ1003-1 and SQ1003-n)

Through the aforementioned process, a desired setting is completed. Therefore, a setting completion notification is transmitted from the network management system NMS2 to an operator OP (sequence SQ1004), and this process is finished.

FIG. 13 illustrates a preliminary path search process S500 executed by the network management system NMS. The network management system NMS that receives a preliminary setting from an operator OP obtains an access point and an SLA type as a presetting (step S501).

Then, candidate combinations of an accommodating node ID NMS-t33 and an accommodating port ID NMS-t34 are extracted as a point capable of serving as an access point by searching the access point management table NMS-t3 using information on this access point (step S502).

For example, if the access unit AE#1 is set as a start point, and the data center DC is set as an endpoint, the following candidates may be extracted.

Start Point Port Candidate:

(1) the accommodating port ID PT#1 of the accommodating unit ID ND#1.

Endpoint Port Candidates:

(A) the accommodating port ID PT#10 of the accommodating unit ID ND#n; and

(B) the accommodating port ID PT#11 of the accommodating unit ID ND#n.

Here, this means that it is necessary to search a path between the start point port candidate and the endpoint port candidate. That is, in this case, the path between (1) and (A) and the path between (1) and (B) become the candidates.

Subsequently, after step S502, a list of routes where the start point and the endpoint can access is searched using the link management table NMS-t5 on the basis of a general route tracing algorithm (such as a multi-path route selection scheme or a Dijkstra's algorithm) (step S503).

Specifically, if there are some routes extending from the start point port to the endpoint port, for example, via a link determined as being available from the link management table NMS-t5, all of such routes are stored in the candidate list.

Subsequently, as a result of step S503, new paths are set for all of the routes satisfying the condition (step S504).

Specifically, a new entry is added to the user management table NMS-t2, and a new path is set as the accommodating path NMS-t23. In addition, a new entry is added to the path configuration table NMS-t4 (the allocated bandwidth NMS-t47 ac set to 0 Mbps (not used), and the accommodated user NMS-t48 is set to an invalid value), and various tables 21 to 26 of the corresponding communication device ND#n are updated. Then, the processing result is notified to an operator.

After step S504, the process is finished (step S505).

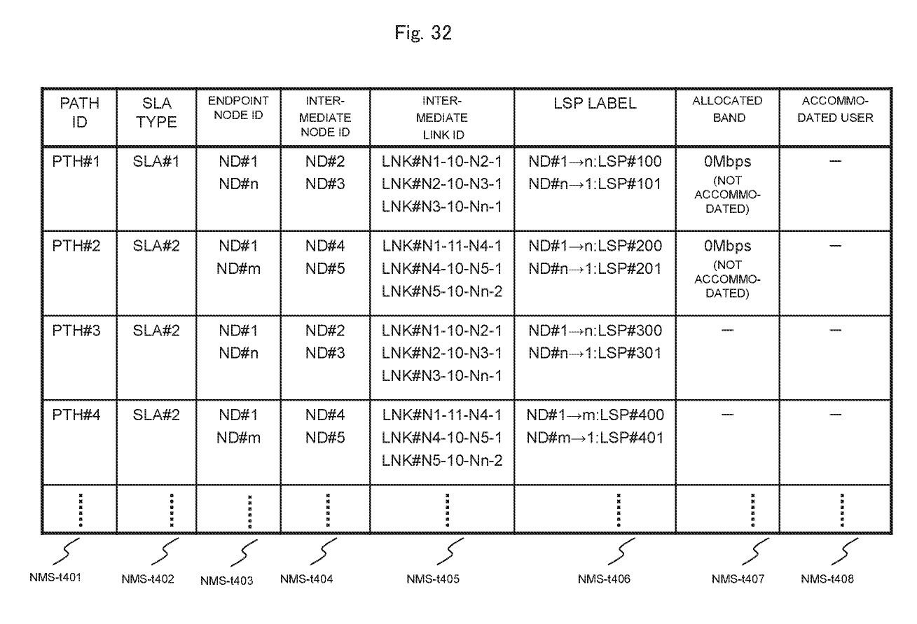

FIG. 32 illustrates a path configuration table NMS-t40 generated by the network presetting sequence SQ1000 from the operator. The path configuration table NMS-t40 is to search table entries indicating a SLA type NMS-t402, an endpoint node ID NMS-t403, an intermediate node ID NMS-t404, an intermediate link ID NMS-t405, an allocated bandwidth NMS-t406, and an accommodated user NMS-t407 by using a path ID NMS-t401 as a search key.

Here, even in the guarantee type service path, the allocated bandwidth NMS-t406 not occupied by a user. Therefore, “0 Mbps” is set, and there is no accommodated user. In addition, even in the fair distribution type service path, the number of accommodated users is zero.

Other parts such as a configuration of the communication system or block configuration of the communication device ND#n and other processes are similar to those of Embodiment 1.

If the processes described above are applied to overall access targets, a plurality of candidate paths can be established for each access point in advance. Therefore, in the service-based path search process S2000 and S2800, it is possible to increase a possibility of accommodating a new user in the existing paths and change a network change more rapidly.

The present invention is not limited to the embodiments described above, and various modifications may be possible. For example, a part of the elements in an embodiment may be substituted with elements of other embodiments. In addition, a configuration of an embodiment may be added to a configuration of another embodiment. Furthermore, a part of the configuration of each embodiment may be added to, deleted from, or substituted with configurations of other embodiments.

In the embodiments described above, those equivalent to software functionalities may be implemented in hardware such as a field programmable gate array (FPGA) or an application-specific integrated circuit (ASIC). The software functionalities may be implemented in a single computer, and any part of the input unit, the output unit, the processing unit, and the storage unit may be configured in other computers connected through a network.

According to the aforementioned embodiments of the present invention, in a virtual network in which the SLA accommodates a plurality of different services, the business user communication service paths necessitating the availability factor guarantee as well as the communication quality and having the same route are consolidated as long as a total sum of the bandwidths guaranteed for each user does not exceed a physical channel bandwidth on the route. Therefore, it is possible to reduce the number of failure detection in the event of a failure while guaranteeing the communication quality.

A failure occurrence in the business user communication service is preferentially notified from the communication device, and the network management system that receives this notification can preferentially execute the loopback test. Therefore, it is possible to rapidly specify a failure portion in the business user communication service path and rapidly perform a maintenance work such as part replacement. As a result, it is possible to satisfy both the communication quality and the availability factor.

Meanwhile, in the public consumer communication service path in which abundant traffics are to accommodated efficiently and fairly between users, considering remaining bandwidths other than the bandwidth occupied for the business user communication path, the remaining bandwidths can be distributed over the entire network at an equal ratio for each user. As a result, it is possible to accommodate abundant traffics while maintaining effectivity and fairness between users.

Since the aforementioned processes are automatically performed in response to a network change request from a user or an application service provider, it is possible to adaptably respond to the request while guaranteeing the SLA. As a result, it is possible to reduce cost by consolidating services communication service providers and improve profitability by providing an optimum network service in a timely manner.

The present invention can be adapted to network administration/management used in various services.

### REFERENCE SIGNS LIST

TE1 to TEn: user terminal

AE1 to AEn: access unit

ND#1 to ND#n: communication device

DC: data center

IN: Internet

MNW: management network

NMS: network management system

MT: monitoring terminal

OP: operator

1. A communication network management method having a plurality of communication devices and a management system, in which a packet is transmitted between the plurality of communication devices through a communication path established by the management system, the method comprising:
establishing the communication path by the management system on the basis of a first establishment policy in which communication paths that share the same route even in a part of the communication network are consolidated for a first service necessitating an availability factor guarantee;
establishing the communication path by the management system on the basis of a second establishment policy in which a route to be used is distributed over the entire communication network for a second service that does not necessitate the availability factor guarantee; and
changing the establishment policy depending on a service type.

2. The communication network management method according to claim 1, wherein, for a route having the same source port and the same destination port on the communication network, the first establishment policy is an establishment policy for consolidating the communication paths.

3. The communication network management method according to claim 1, wherein the first service is a service for obtaining a predetermined bandwidth for each user or for each service,
if a total sum of bandwidths of the services consolidated in the same route exceeds any one of the channel bandwidths on the communication path, the management system performs control on the basis of the first establishment policy such that a new route having a total sum of the service bandwidths consolidated in the same route that does not exceed any one of the channel bandwidths on the communication path is searched, and the communication path is newly established in the corresponding route to accommodate a user or a service,
the management system distributes a communication path for the second service to remaining bandwidths except for bandwidths to be occupied for the first service out of each channel bandwidths on the route on the basis of the second establishment policy.

4. The communication network management method according to claim 1, wherein, when the communication path is changed in response to a request from an external system connected to the communication network, the management system automatically apples the establishment policies.

5. The communication network management method according to claim 3, wherein, if there is a change of setting into the bandwidth to be occupied for the first service, the management system sets the communication path again such that the remaining bandwidth changed by this change is distributed to users of the second service at an equal ratio.

6. The communication network management method according to claim 1, wherein the management system searches routes for each service and sets them in advance before a user is accommodated, and
the user is newly accommodated in the communication path in response to a user accommodation setting request.

7. The communication network management method according to claim 1, wherein, when a failure is detected in the plurality of communication paths, the communication device preferentially notifies the management system of the failure of the communication path relating to the first service.

8. The communication network management method according to claim 7, wherein the management system that receives failure notification preferentially processes the failure notification for the first service and automatically execute a loopback test or urges an operator to execute the loopback test.

9. A communication network management system for managing a plurality of communication devices in a communication network in which a communication path for first service that guarantees a bandwidth for a user and a communication path for a second service that does not guarantee a bandwidth for a user are established, and the communication paths for the first and second services coexist in the communication network,
wherein the communication network management system applies a first establishment policy in which a new communication path is established in a route selected from routes having unoccupied bandwidths corresponding to the guarantee bandwidth in response to a new communication path establishment request for the first service, and
the communication network management system applies a second establishment policy in which the new communication path is established in a route selected from unoccupied bandwidths allocated to the second service user in response to a new communication path establishment request for the second service.

10. The communication network management system according to claim 9, wherein, on the basis of the first establishment policy, the new communication path is established by selecting a route having a minimum unoccupied bandwidth or a bandwidth equal to or smaller than a predetermined threshold, from routes having the unoccupied bandwidth corresponding to the guarantee bandwidth, and
on the basis of the second establishment policy, the new communication path is established by selecting a route having a maximum unoccupied bandwidth allocated to each second service user or a bandwidth equal to or higher than a predetermined threshold.

11. The communication network management system according to claim 9, wherein data are stored such that an identifier that identifies the user, an SLA type of the service provided to the user, and the establishment policy applied to the SLA type are associated with each other.

12. A communication network comprising:
a plurality of communication devices that constitute a route; and
a management system that establishes a communication path occupied by a user across the plurality of communication devices,
wherein the management system establishes a first service communication path and a second service communication path having different SLAs for the user's occupation,
the first service communication path is established such that the first service communication paths are consolidated into a particular route in the network, and
the second service communication path is established such that the second service communication paths are distributed to routes over the network.

13. The communication network according to claim 12, wherein the first service is a service in which an availability factor and a bandwidth are guaranteed, and
if a plurality of communication paths used for plurality of users provided with the first service have the same source port and the same destination port over the network, the plurality of communication paths are established in the same route.

14. The communication network according to claim 12, wherein the second service is a best-effort service, and
the second service communication path is established such that the unoccupied bandwidths except for the communication bandwidth used by the first service communication path are evenly allocated to the second service users.

15. The communication network according to claim 12, wherein the communication device has a failure management unit that manages a failure in the communication path, and
the failure management unit changes a priority of troubleshooting depending on whether the failed communication path is the first service communication path or the second service communication path.
